(19) United States
(12) Patent Application Publication
(10) Pub. No.: US 2017/0263016 A1
(43) Pub. Date: Sep. 14, 2017

(54) COMPUTER-READABLE STORAGE MEDIUM STORING MANAGEMENT PROGRAM, MANAGEMENT APPARATUS, AND MANAGEMENT METHOD

(71) Applicant: FUJITSU LIMITED, Kawasaki-shi (JP)

(72) Inventor: Takahiro NODERA, Kawasaki (JP)

(73) Assignee: FUJITSU LIMITED, Kawasaki-shi (JP)

(21) Appl. No.: 15/372,897

(22) Filed: Dec. 8, 2016

(30) Foreign Application Priority Data
Mar. 10, 2016 (JP) 2016-046430

(51) Int. Cl. G06T 7/73; G06T 7/62

(52) U.S. Cl. CPC G06T 7/73; G06T 7/62; G06T 2207/10016

(57) ABSTRACT

A non-transitory, computer-readable recording medium having stored therein a management program for causing a computer to execute acquiring an image of a rack and a device mounted in the rack; and specifying a position of the device mounted in the rack, in the rack based on the image and correspondence information representing correspondences between aspect ratios of devices mountable in the rack and unit sizes in the rack, each of the unit sizes having a minimum housing space that accommodates the device.

### CROSS-REFERENCE TO RELATED APPLICATION

This application is based upon and claims the benefit of priority of the prior Japanese Patent Application No. 2016-046430, filed on Mar. 10, 2016, the entire contents of which are incorporated herein by reference.

### FIELD

The embodiments discussed herein are related to a computer-readable storage medium storing a management program, a management apparatus, and a management method.

### BACKGROUND

An information processing system uses various types of equipment such as server computers, storage devices, and network equipment. These types of equipment are accommodated and managed in a rack capable of accommodating multiple devices. Herein, such an information processing system is capable of using a large number of devices. In operation management of an information processing system, it is sometimes desired to know the position where each device is located. This is for implementing efficient management, maintenance and the like of information assets. Accordingly, consideration is being made on a method of assisting recognition of positions where the devices are mounted in a rack.

In an example proposed as such a method, non-contact (integrated circuit (IC) tags storing information of rack-mount devices mounted in a rack frame are attached to the respective rack-mount devices, and a reader device which reads the non-contact IC tags is provided for each shelf of the rack frame. In this proposition, the reader device on each shelf of the rack frame reads the non-contact IC tag of the rack-mount device mounted on the shelf to acquire the information and the mounting position of the rack-mount device.

In another proposition, a server mounted in a rack acquires a shelf signal value output from a signal output section of the shelf where the server is mounted and determines the mounting position of the server in the rack. In still another proposition, images of light emitting diodes (LEDs) of multiple devices are captured with a single camera using multiple optical fiber scopes, and management information is input based on colors of the images or based on blinks of the LEDs.

Such related techniques are disclosed for example in Japanese Laid-open Patent Publication Nos. 2007-226582, 2011-165104, and 2012-238116.

As described above, in the method of specifying the position of each device in the rack by communication between the rack and the rack-mount device, special communication modules have to be provided for both of the rack and rack-mount devices. On the other hand, some racks and some rack-mount devices are not equipped with such communication modules, and the aforementioned method is not applicable. Accordingly, the problem is how to implement a mechanism to manage the mounting position of each rack-mount device even when the rack and rack-mount devices are not equipped with special communication modules.

### SUMMARY

According to an aspect of the embodiments, a non-transitory, computer-readable recording medium having stored therein a management program for causing a computer to execute acquiring an image of a rack and a device mounted in the rack; and specifying a position of the device mounted in the rack, in the rack based on the image and correspondence information representing correspondences between aspect ratios of devices mountable in the rack and unit sizes in the rack, each of the unit sizes having a minimum housing space that accommodates the device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a management apparatus according to a first embodiment;

FIG. 2 is a diagram illustrating examples of racks of a second embodiment;

FIG. 3 is a diagram illustrating an operation management system of the second embodiment;

FIG. 4 is a diagram illustrating a hardware example of a management server of the second embodiment;

FIG. 5 is a diagram illustrating a hardware example of a terminal device of the second embodiment;

FIG. 6 is a diagram illustrating a hardware example of a rack-mount device of the second embodiment;

FIG. 7 is a diagram illustrating function examples of the management server of the second embodiment;

FIGS. 8A and 8B are diagrams illustrating examples of creating edge images in the second embodiment;

FIGS. 9A and 9B are diagrams illustrating examples of detecting LED outlines in edge images in the second embodiment;

FIG. 10 is a diagram illustrating an example of a ratio table of the second embodiment;

FIG. 11 is a diagram illustrating an example of a reference length table of the second embodiment;

FIG. 12 is a diagram illustrating an example of a rack management table of the second embodiment;

FIG. 13 is a diagram illustrating an example of a device management table of the second embodiment;

FIG. 14 is a diagram illustrating examples of output images of the second embodiment;

FIG. 15 is a flowchart illustrating a processing example of the management server of the second embodiment;

FIG. 16 is a flowchart illustrating an example of rack registration of the second embodiment;

FIG. 17 is a flowchart illustrating an example of reference length definition of the second embodiment;

FIG. 18 is a flowchart illustrating an example of rack size measurement of the second embodiment;

FIG. 19 is a diagram illustrating an example of reference length definition in the process of rack registration of the second embodiment;

FIG. 20 is a diagram illustrating an example of rack size measurement of the second embodiment;

FIG. 21 is a flowchart illustrating an example of device registration of the second embodiment;

FIG. 22 is a flowchart illustrating an example of LED outline specification of the second embodiment;

FIG. 23 is a diagram illustrating an example of blinking of an LED of the second embodiment;

FIG. 24 is a flowchart illustrating an example of device mounting position specification of the second embodiment;

FIG. 25 is a diagram illustrating an example of reference length definition in the process of device mounting position specification of the second embodiment;

FIG. 26 is a diagram illustrating an example of device mounting position specification of the second embodiment;

FIG. 27 is a diagram illustrating the example of device mounting position specification (continued) of the second embodiment;

FIG. 28 is a flowchart illustrating an example of rack registration of a third embodiment;

FIG. 29 is a diagram illustrating an example of a panorama image of the third embodiment; and

FIG. 30 is a flowchart illustrating an example of device registration of the third embodiment.

### DESCRIPTION OF EMBODIMENTS

Hereinafter, a description is given of embodiments with reference to the drawings.

### First Embodiment

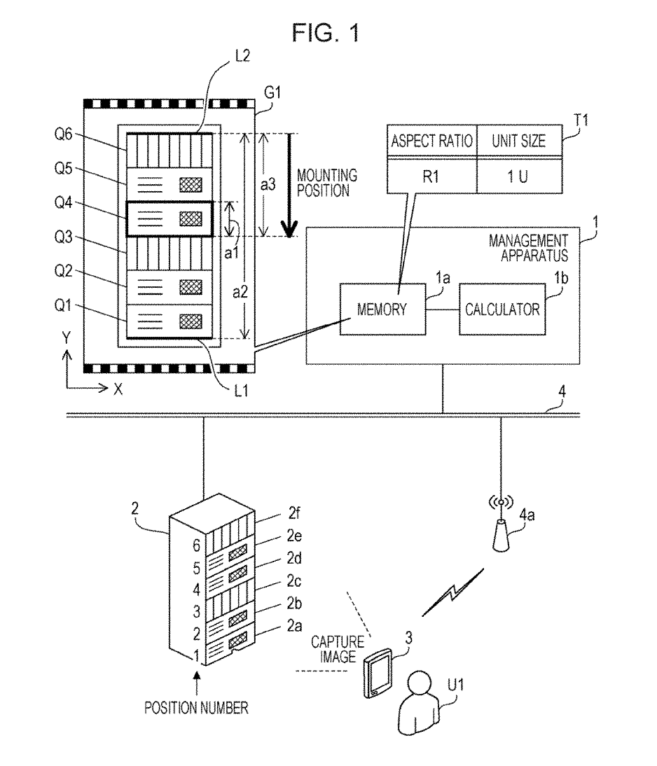

FIG. 1 is a diagram illustrating a management apparatus of a first embodiment. A management apparatus 1 manages information of various devices including a server computer, a storage device, and a network device. The information of each device includes the model name, the model number, and the address used in communication. Each device is mounted in a rack 2. In the following description, the devices mounted in the rack 2 are also referred to as rack-mount devices. In the rack 2, rack-mount devices 2a, 2b, 2c, 2d, 2e, and 2f are mounted, for example. The management apparatus 1 communicates with a terminal device 3 used by a user U1 and manages positions in the rack 2 (mounting positions) where the rack-mount devices 2a, 2b, 2c, 2d, 2e, and 2f are mounted.

The mounting positions in the rack 2 are identified by position numbers indicating the positions in the rack 2. Specifically, the rack-mount device 2a is mounted at the position with a position number of 1. The rack-mount device 2b is mounted at the position with a position number of 2. The rack-mount device 2c is mounted at the position with a position number of 3. The rack-mount device 2d is mounted at the position with a position number of 4. The rack-mount device 2e is mounted at the position with a position number of 5. The rack-mount device 2f is mounted at the position with a position number of 6.

The management apparatus 1 and rack-mount devices 2a, 2b, 2c, 2d, 2e, and 2f are connected to a network 4 and communicate with each other. The terminal device 3 is connected to the network 4 through a relay unit 4a and communicates with the management apparatus 1. The relay unit 4a is a wireless access point establishing a wireless link with the terminal device 3, for example. The relay unit 4a may be connected to the terminal device 3 by wire.

The management apparatus 1 includes a memory 1a and a processor 1b. The memory 1a may be a volatile storage device such as a random access memory (RAM) or may be a non-volatile storage device such as a hard disk drive (HDD) or a flash memory. The processor 1b may be one of a central processing unit (CPU), a digital signal processor (DSP), an application specific integrated circuit (ASIC), a field programmable gate array (FPGA), and the like. The processor 1b may be a processor executing a program. The term “processor” herein may include an assembly of multiple processors (a multi-processor).

The memory 1a stores a ratio table T1. The ratio table T1 is correspondence information representing correspondence between the aspect ratio of each device mounted in the rack 2 and the unit size thereof in the rack 2. For example, information of a unit size of 1U (U is an abbreviation of unit) is registered corresponding to an aspect ratio of R1 in the ratio table T1.

The front of each rack-mount device mounted in the rack 2 is rectangular in the front view of the rack 2. The aspect ratio refers to the ratio of the horizontal length to the vertical length (=horizontal length/vertical length) of a rectangle of the rack-mount device in the front view of the rack 2. The unit size corresponds to the quantity of housing spaces (housing sections) in the rack 2 for accommodating a device corresponding to the aspect ratio. For example, the unit size 1U corresponds to the minimum housing space in the rack 2 that accommodates a device. The record in the ratio table T1 represents that housing a device with an aspect ratio of R1 takes a housing space of 1U in the rack 2. The same record also represents that the size of the device with an aspect ratio of R1 is 1U. The horizontal size of the housing space in the front view of the rack 2 does not vary. “1U” is therefore considered to correspond to the height-direction size of the minimum housing space that accommodates one device. The height-direction size of rack-mount devices may be 2U (twice “1U” in the height direction), 3U (three times “1U” in the height direction), and so on.

The processor 1b acquires an image of the rack 2 and devices mounted in the rack 2 captured with the terminal device 3. The terminal device 3 includes an image capturing function to take still pictures and shoot videos. For example, the terminal device 3 captures an image of the front of the rack 2, generates image data G1 including images of the rack 2 and the devices mounted in the rack 2, and transmits the image data G1 to the management apparatus 1.

The image data G1 includes the frame of the rack 2 in the front view of the rack 2 and images Q1, Q2, Q3, Q4, Q5, and Q6 (the front of each rack-mount device in the front view of the rack 2) of the rack-mount devices 2a, 2b, 2c, 2d, 2e, and 2f. The image Q1 is an image of the rack-mount device 2a. The image Q2 is an image of the rack-mount device 2b. The image Q3 is an image of the rack-mount device 2c. The image Q4 is an image of the rack-mount device 2d. The image Q5 is an image of the rack-mount device 2e. The image Q6 is an image of the rack-mount device 2f. The X-axis direction and Y-axis direction in the image data G1 correspond to the horizontal direction and vertical direction, respectively. The processor 1b receives the image data G1 transmitted from the terminal device 3.

The processor 1b specifies the position of a rack-mount device in the rack 2 based on the images and the information (the ratio table T, for example) representing the correspondence between the aspect ratio of the device and the unit size in the rack 2.

The processor 1b sequentially detects rectangles corresponding to the rack-mount devices 2a, 2b, 2c, 2d, 2e, and 2f from the image data G1, for example. In the process of detecting rectangles, the processor 1b may be configured to generate an edge image obtained by performing predetermined edge enhancement for the image data G1 to facilitate detecting the rectangles. The edge enhancement is a process to create another image (referred to as an edge image) with boundaries between contrasting colors being emphasized in the image. The processor 1b may detect rectangles corresponding to the rack-mount devices 2a, 2b, 2c, 2d, 2e, and 2f from the edge image created based on the image data G1. The edge image is considered as an example of the “image of the rack 2 and devices mounted in the rack 2”.

The processor 1b may determine which rack-mount device corresponds to the detected rectangle, based on the comparison between a first aspect ratio of the detected rectangle and a second aspect ratio (the aspect ratio “R1”) registered in the ratio table T1.

The processor 1b determines that the detected rectangle is a rectangle corresponding to any one of the rack-mounted devices when the first aspect ratio is equal to the quotient of division of the second aspect ratio by an integer n (n is an integer not less than 1) with a predetermined accuracy, for example. On the other hand, the processor 1b determines that the detected rectangle does not correspond to any of the rack-mount devices when the first aspect ratio is not equal to the quotient of division of each second aspect ratio by an integer n with the predetermined accuracy.

In some cases, the rack 2 includes a blank panel or a vacant housing space. In the rack 2, blank panels and vacant housing spaces are distinguished by the above-described method because the aspect ratio of a blank panel or a vacant housing space in the front view of the rack 2 is different from the aspect ratios of the rack-mount devices. In some racks, however, blank panels and vacant housing spaces may not be distinguished. In such a case, the processor 1b may falsely detect that a rectangle corresponding to a blank panel or a vacant housing space is a rectangle corresponding to any rack-mount device. Accordingly, information of patterns such as figures and colors in the fronts of blank panels and patterns of color (black or the like) of vacant housing spaces may be previously stored in the memory 1a. The processor 1a therefore removes rectangles having a specific pattern inside from the candidates to be extracted with reference to the information stored in the memory 1a. Alternatively, the processor 1b may specify a rectangle corresponding to each rack-mount device by causing the rack-mount device to perform a predetermined operation and detecting the region including the operation based on the image data as described later.

When the detected rectangle is a rectangle corresponding to one of the rack-mount devices, the processor 1b calculates the vertical length of the detected rectangle in the image data G1 (or the edge image corresponding to the image data G1). It is assumed that the processor 1b detects the rectangle corresponding to the image Q4 corresponding to the rack-mount device 2d, for example. In this case, the processor 1b calculates vertical length a1 for the image Q4. The processor 1b then calculates length a1/n as vertical length corresponding to 1U in the image data G1.

The processor 1b detects a lower side L1 of a housing space at the bottom (a housing space corresponding to the mounting position “1”) in the image of the rack 2 in the image data G1 and an upper side L2 of a housing space at the top (a housing space corresponding to the mounting position “6”). The processor 1b may detect the sides L1 and L2 using the above-described edge image. The processor 1b calculates length a2 between the sides L1 and L2. The processor 1b then calculates height H of the entire housing space of the rack 2 as: H=a2/(a1/n)=n×(a2/a1). In the aforementioned example, H=6 (U). The processor 1b detects six housing spaces in the rack 2 which are indicated by position numbers of “1”, “2”, “3”, “4”, “5”, and “6”, respectively.

The processor 1b detects the lower side (or the upper side) extending in the horizontal direction in the image Q4 with reference to the image data G1 (or the edge image corresponding to the image data G1) and calculates length a3 between the detected lower side and the side L2. The processor 1b calculates a number H1 of housing spaces located from the housing space at the top of the rack 2 to the mounting position of the rack-mount device 2d as: H1=a3/(a1/n)=n×(a3/a1). This represents that the rack-mount device 2d is mounted at the mounting position of the H1-th housing space from the top housing space of the rack 2. In the above-described example, H1=3 (U). The processor 1b therefore specifies the mounting position of the rack-mount device 2d corresponding to the image Q4 with the position number “4”, which, counting back from 6, is located in the third position from the top housing space of the rack 2. When the rack-mount device has a height of 2U or greater, the rack-mount device occupies the quantity of housing spaces corresponding to the height of the rack-mount device from the specified mounting position. The processor 1b may be configured to acquire the height-direction size of each rack-mount device from the rack-mount device as device information described later. In the aforementioned example, the processor 1b calculates the number H1 of housing spaces located from the detected device to the top of the rack 2. However, the processor 1b specifies the mounting position in a similar manner by calculating the quantity of housing spaces located from the detected device to the bottom of the rack 2.

The processor 1b specifies the mounting position of the rack-mount device 2d as the position number “4” and stores the specified position number in the memory 1a in association with the device information of the rack-mount device 2d. The processor 1b may acquire the device information by various methods. The methods are as follows specifically.

In a first method, the processor 1b acquires information input by the user U1 through the terminal device 3. For example, the processor 1b may prompt the user U1 to input the device information by displaying an image with the image Q4 enhanced, which is detected as a rectangle corresponding to the rack-mount device 2d in the image data G1 on the terminal device 3 to provide the same to the user U1.

In a second method, a list of address information including Internet protocol (IP) addresses of respective rack-mount devices to be mounted in the rack 2 is previously registered in the memory 1a. In this case, the processor 1b collects the device information from the rack-mount devices indicated by the address information stored in the memory 1a. For example, the processor 1b selects a set of address information and transmits a request to transmit device information to the rack-mount device indicated by the selected set of address information. The processor 1b receives device information as a response to the request to transmit. The processor 1b does not know which rack-mount device in the rack 2 has responded the device information when the request to transmit device information is transmitted only with the address information being specified.

In the second method, the processor 1b causes the rack-mount device indicated by the address information to execute a predetermined operation which is recognizable in an image of the front view of the rack 2. To be more specific, a certain LED provided on a front panel of the rack-mount device is caused to blink in a predetermined cycle. Alternatively, a medium housing section (a compact disc (CD) tray, for example) provided in the front panel of the rack-mount device is caused to open and close. The processor 1b causes the terminal device 3 to shoot a video of the rack-mount device in the rack 2 which is performing the predetermined operation and acquires the shot video from the terminal device 3. The processor 1b analyses data of the video to specify an image part including changes corresponding to the predetermined operation in the video data as an image part corresponding to the rack-mount device which has transmitted the device information. The processor 1b then specifies a rectangle including the specified image part and then specifies the mounting position of the rack-mount device as illustrated with the image data G1. The processor 1b then stores the specified mounting position in the memory 1a in association with the device information. In some cases, the rack 2 includes a blank panels or a vacant housing space as described above. In this case, the processor 1b may extract a rectangle corresponding to a blank panel or a vacant housing space from the image data G1. By using the second method, the processor 1b is not caused to falsely detect a rectangle corresponding to a blank panel or a vacant housing space as a rectangle corresponding to the rack-mount device of interest, without previously registering in the memory 1a, the patterns that is excluded from the candidates to be extracted.

In another configuration, the position of each rack-mount device may be recognized through communication between communication modules which transmit and receive information specifying the position in the rack and are provided in both the rack and rack-mount device. However, the rack and rack-mount device are not equipped with such communication modules in some cases. In such a case, the user U1 manually inputs device information of each rack-mount device and information of the mounting position in the management apparatus 1. The manual input results in the user spending more time and effort as the quantity of devices to be managed is greater. Alternatively, the rack and rack-mount device may be replaced with a rack and a rack-mount device provided with special communication modules. However, this causes problems of cost (expense, period until replacement, and man-hours) to obtain a new rack and a rack-mount device for replacement.

On the other hand, according to the management apparatus 1, the mounting position of each rack-mount device in the rack 2 is specified and managed in association with the device information based on the ratio table T1 and image data G1. Accordingly, special communication modules may not be provided in the racks and rack-mount devices. It is therefore possible to facilitate managing the mounting position of each rack-mount device in the rack 2. Moreover, it is possible to assist the user U1 to implement efficient management of the information assets and reduce the time and effort spent by the user U1 for operation management.

Next, the function of properly managing the mounting positions in a rack is described more specifically by illustrating an operation management system which manages information assets including a server computer mounted in the rack 2.

### Second Embodiment

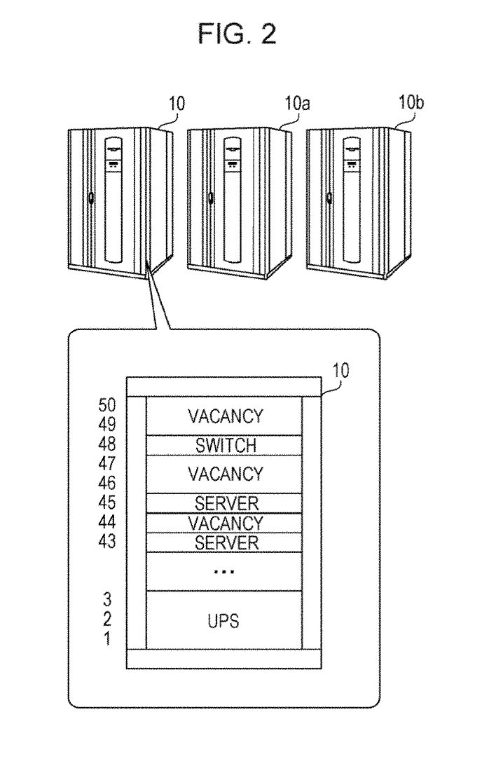

FIG. 2 is a diagram illustrating an example of a rack of the second embodiment. A system of the second embodiment includes racks 10, 10a, and 10b. Each of the racks 10, 10a, and 10b includes multiple housing spaces (also referred to as housing sections or housing shelves) arranged in the direction (in the height direction) vertical to the floor surface. Various types of devices are mountable in respective housing spaces (or across two or more housing spaces). For example, the racks 10, 10a, and 10b are capable of housing various types of devices, such as server computers (just referred to as servers sometimes), storage devices, network devices (switches, routers, load balancers, firewalls, and the like), for example. The entire height of the housing spaces of each of the racks 10, 10a, and 10b is 50U, for example. The entire height of the housing spaces of each of the racks 10, 10a, and 10b may be other than 50U (for example, the entire heights of the housing spaces of the racks 10, 10a and 10b are 50U, 40U, and 30U, respectively).

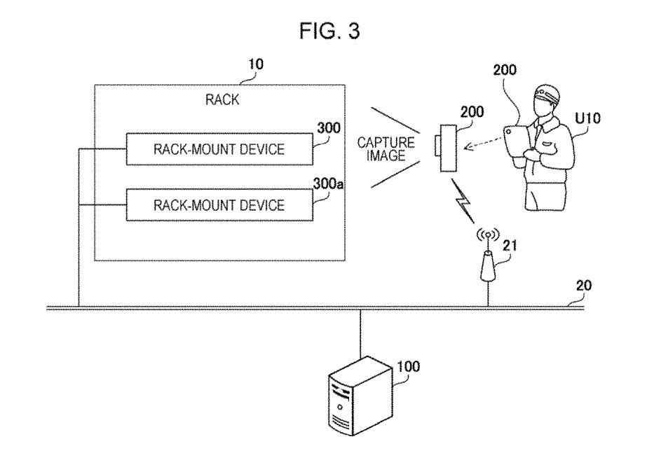

FIG. 3 is a diagram illustrating an example of an operation management system of the second embodiment. Hereinafter, a description is mainly given of the rack 10, and the description of the racks 10a and 10b is omitted. A management server 100 manages the rack-mount devices in the racks 10a and 10b in a similar manner to those in the rack 10.

The operation management system of the second embodiment includes a management server 100, a terminal device 200, and rack-mount devices 300 and 300a. The management server 100 and rack-mount devices 300 and 300a are connected to a network 20. The terminal device 200 is connected to the network 20 via an access point 21. The network 20 is a local area network (LAN) provided in a data center or a server room, for example. The rack-mount devices 300 and 300a are mounted in the rack 10. The rack 10 is capable of housing rack-mount devices other than the rack-mount devices 300 and 300a.

The management server 100 is a server computer which manages mounting positions of the rack-mount devices 300 and 300a in the rack 10. The management server 100 is capable of communicating with the terminal device 200 and the rack-mount devices 300 and 300a through the network 20. The management server 100 is an example of the management apparatus 1 of the first embodiment.

The terminal device 200 is a client computer used by a user U10. The terminal device 200 may be a smart device such as a smart phone or a tablet device. The terminal device 200 is provided with a camera function and is capable of generating still pictures and video. The terminal device 200 captures an image of the front of the rack 10 to generate a still picture or a video, for example. When the rack 10 has a door, the image capturing of the front of the rack 10 is performed with the door opened.

The rack-mount devices 300 and 300a are devices mounted in the rack 10. The rack-mount devices 300 and 300a may be various devices having different sizes and purposes as described above. The rack-mount devices 300 and 300a mounted in the rack 10 have the same size in the lateral direction. The rack-mount devices 300 and 300a have different sizes in the height direction of the rack 10.

The size of devices mountable in the rack 10 is determined by standards. Specifically, according to electronic industries alliance (EIA) standards, the horizontal width of devices is defined as 19 inch (482.6 mm), and the height thereof is defined as multiples of 1.75 inch (44.45 mm). In the EIA standards, “1U” is 1.75 inch (44.45 mm) as the unit length in the height direction.

According to the Japanese industrial standards (JIS), the horizontal width of devices is defined as 480 mm, and the height thereof is defined as multiples of 50 mm. In the JIS, “1U” is 50 mm as the unit length in the height direction.

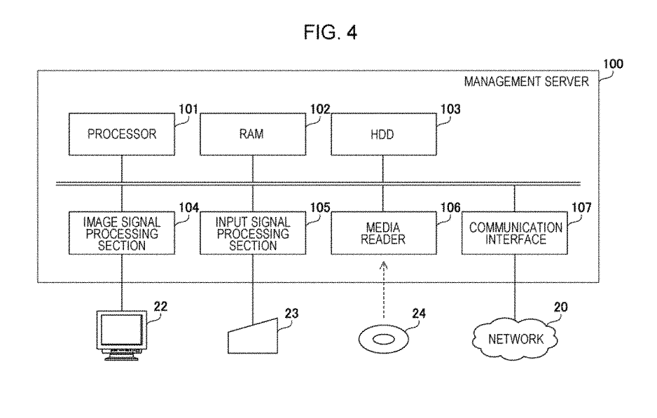

FIG. 4 is a diagram illustrating a hardware example of a management server of the second embodiment. The management server 100 includes a processor 101, a RAM 102, an HDD 103, an image signal processing section 104, an input signal processing section 105, a media reader 106, and a communication interface 107. Each section is connected to a bus of the management server 100.

The processor 101 controls information processing of the management server 100. The processor 101 may be a multiprocessor. The processor 101 is a CPU, a DSP, an ASIC, an FPGA, or the like, for example. The processor 101 may be composed of a combination of two or more of a CPU, a DSP, an ASIC, an FPGA, and the like.

The RAM 102 is a main storage device of the management server 100. The RAM 102 temporarily stores the operating system (OS) program and at least a part of application programs to be executed by the processor 101. The RAM 102 also stores various types of data used in processing by the processor 101.

The HDD 103 is an auxiliary storage device of the management server 100. The HDD 103 magnetically writes and reads data in and from a magnetic disk inside. The HDD 103 may store the OS program, application programs, and various types of data. The management server 100 may include another type of auxiliary storage device such as a flash memory or a solid state drive (SSD) and may include multiple auxiliary storage devices.

The image signal processing section 104 outputs an image to a display 22 connected to the management server 100 in accordance with an instruction from the processor 101. The display 22 is a cathode ray tube (CRT) display, a liquid crystal display, or the like.

The input signal processing section 105 acquires input signal from an input device 23 connected to the management server 100 and outputs the acquired input signal to the processor 101. The input device 23 is a pointing device such as a mouse or a touch panel, a keyboard, and the like, for example.

The media reader 106 is a device to read programs and data recorded in a recording medium 24. The recording medium 24 is a magnetic disc, such as a flexible disk (FD) or an HDD, an optical disk such as a CD or a digital versatile disc (DVD), or a magneto-optical disk (MO), for example. The recording medium 24 may be a non-volatile semiconductor memory such as a flash memory card, for example. The media reader 106 may store a program or data read from the recording medium 24 in the RAM 102 or HDD 103 in accordance with an instruction from the processor 101, for example.

The communication interface 107 communicates with another device via the network 20. The communication interface 107 may be either a wired communication interface or a wireless communication interface.

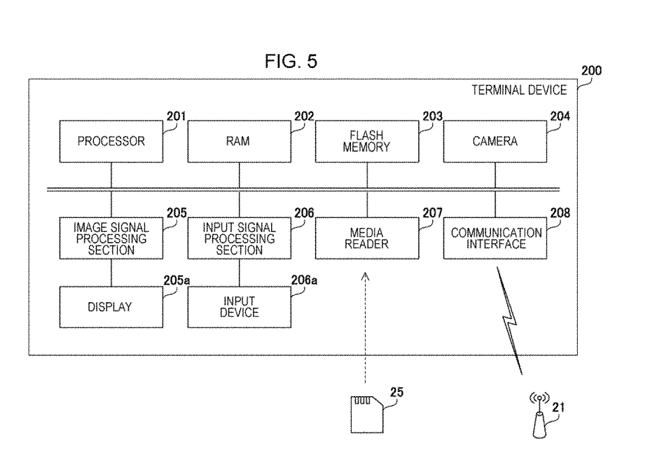

FIG. 5 is a diagram illustrating a hardware example of a terminal device of the second embodiment. The terminal device 200 includes a processor 201, a RAM 202, a flash memory 203, a camera 204, an image signal processing section 205, a display 205a, an input signal processing section 206, an input device 206a, a media reader 207, and a communication interface 208. Each section is connected to a bus of the terminal device 200.

The processor 201 controls information processing of the terminal device 200. The processor 201 may be a multiprocessor. The processor 201 is a CPU, a DSP, an ASIC, an FPGA, or the like, for example. The processor 201 may be composed of a combination of two or more of a CPU, a DSP, an ASIC, an FPGA, and the like.

The RAM 202 is a main storage device of the terminal device 200. The RAM 202 temporarily stores the OS program and at least a part of application programs to be executed by the processor 201. The RAM 202 also stores various types of data used in processing by the processor 201.

The flash memory 203 is an auxiliary storage device of the terminal device 200. The flash memory 203 stores the OS program, application programs, and various types of data.

The camera 204 is an image capturing device mounted in the terminal device 200. The camera 204 includes an image capturing device such as a charge-coupled device (CCD) image sensor. The camera 204 generates data of a still picture or a video of a view in which the lens of the camera 204 is directed, in accordance with an instruction from the processor 201.

The image signal processing section 205 outputs an image to a display 205a in accordance with an instruction from the processor 201. The display 205a is a liquid crystal display, for example.

The input signal processing section 206 acquires an input signal from an input device 206a, which is connected to the terminal device 200, and outputs the acquired input signal to the processor 201. The input device 206a is a pointing device such as a touch panel, for example.

The media reader 207 is a device to read programs and data recorded in a recording medium 25. The recording medium 25 is a flash memory card, for example. The media reader 207 stores a program or data read from the recording medium 25 in the RAM 202 or flash memory 203, in accordance with an instruction from the processor 201, for example.

The communication interface 208 is a wireless communication interface which establishes a wireless link with the access point 21 and communicates with another device via the access point 21 and network 20. The communication interface 208 may be a wired communication interface connected to the network 20 by wire.

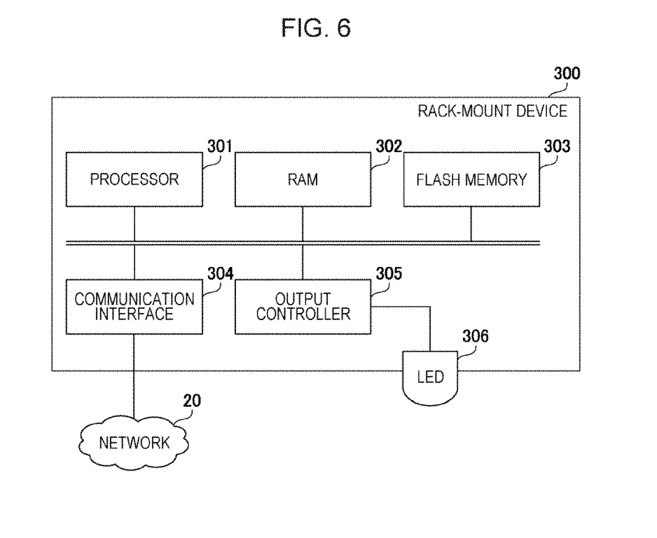

FIG. 6 is a diagram illustrating a hardware example of a rack-mount device of the second embodiment. The rack-mount device 300 includes a processor 301, a RAM 302, a flash memory 303, a communication interface 304, an output controller 305, and an LED 306. Each section is connected to a bus of the rack-mount device 300.

The processor 301 controls information processing of the rack-mount device 300. The processor 301 may be a multiprocessor. The processor 301 is a CPU, a DSP, an ASIC, an FPGA, or the like, for example. The processor 301 may be composed of a combination of two or more of a CPU, a DSP, an ASIC, an FPGA, and the like.

The RAM 302 is a main storage device of the rack-mount device 300. The RAM 302 temporarily stores the OS program and at least a part of application programs to be executed by the processor 301. The RAM 302 also stores various types of data used in processing by the processor 301.

The flash memory 303 is an auxiliary storage device of the rack-mount device 300. The flash memory 303 stores the OS program, application programs, and various types of data.

The communication interface 304 communicates with another device via the network 20. The communication interface 304 may be either a wired communication interface or a wireless communication interface.

The output controller 305 controls the turning on/off of the LED 306 in accordance with an instruction from the processor 301. The LED 306 is a semiconductor device emitting light under control of the output controller 305. The LED 306 is also called a light emitting section. The rack-mount device 300 may include a light emitting section capable of being turned on/off under control of the output controller 305, in addition to the LED 306. The LED 306 is provided so as to be checked on the front of the rack-mount device 300 mounted in the rack 10 and is viewable when the rack 10 is seen from the front.

Rack-mount devices (including the rack-mount device 300a) other than the rack-mount device 300 are implemented by hardware similar to the rack-mount device 300. The hardware provided in each rack-mount device varies depending on the type of the rack-mount device. When the rack-mount device 300 is a server computer, for example, the rack-mount device 300 sometimes includes another type of auxiliary storage device such as an HDD instead of or in addition to the flash memory 303. In this case, the rack-mount device 300 may include an image signal processing section, an input signal processing section, and a media reader in a similar manner to the management server 100.

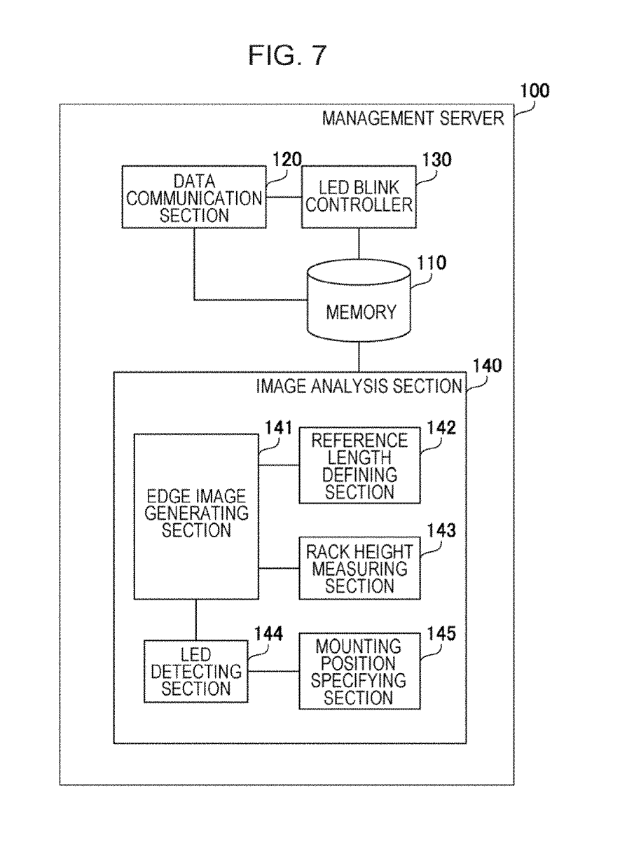

FIG. 7 is a diagram illustrating a function example of a management apparatus of the second embodiment. The management server 100 includes a memory 110, a data communication section 120, an LED blink controller 130, and an image analysis section 140. The memory 110 is implemented as a storage region secured in the RAM 102 or the HDD 103. The functions of the data communication section 120, LED blink controller 130, and image analysis section 140 are exerted by the processor 101 executing the programs stored in the RAM 102.

The memory 110 stores rack management information concerning the racks 10, 10a, and 10b and device management information concerning the multiple rack-mount devices including the rack-mount devices 300 and 300a. The memory 110 previously stores a list of IP addresses of rack-mount devices for each rack number. The memory 110 stores ratio information representing the correspondence relationship between the aspect ratio and the height (unit: U) of the front view of each rack-mount device to be mounted in each of the racks 10, 10a, and 10b.

The data communication section 120 performs data communication with the terminal device 200 and multiple rack-mount devices including the rack-mount devices 300 and 300a. The data communication section 120 transmits an instruction to capture an image of a rack (the rack 10, for example) to the terminal device 200. The terminal device 200 takes an image of the front of the rack 10 and responds image data (data of a still picture or a video) including the image of the front of the rack 10 to the management server 100. The data communication section 120 receives the image data from the terminal device 200 and stores the received image data in the memory 110. The data communication section 120 selects the IP addresses of the rack-mount devices in the rack 10 one by one with reference to the memory 110. The data communication section 120 transmits a request to transmit information (referred to as device information) of the rack-mount device (the rack-mount device 300, for example) corresponding to the selected IP address. The data communication section 120 receives the device information as a response to the request to transmit and stores the received device information in the memory 110.

The LED blink controller 130 transmits an instruction to blink an LED to the rack-mount device 300, to which the request to transmit the device information has been transmitted. The LED blink controller 130 makes the instruction to blink an LED in cooperation with the instruction from the data communication section 120 to the terminal device 200 to capture an image of the rack 10.

The image analysis section 140 analyses the image data acquired by the data communication section 120. The image analysis section 140 includes an edge image generating section 141, a reference length defining section 142, a rack height measuring section 143, an LED detecting section 144, and a mounting position specifying section 145.

The edge image generating section 141 generates an edge image by performing edge enhancement for the image data acquired by the data communication section 120. The reference length defining section 142 calculates length (reference length) in the edge image corresponding to a height of 1U in the rack 10 based on the size of the rectangle which is included in the edge image and corresponds to an outer edge of a rack-mount device and the ratio information stored in the memory 110. The reference length defining section 142 stores the calculated reference length in the memory 110. The length of a certain line in an image is considered as the quantity of pixels used to draw the line when the image is displayed on the display 22 at the same magnification (without being zoomed) or an amount corresponding to the quantity of pixels.

The rack height measuring section 143 calculates the length between the lower side of the bottom housing space of the rack 10 and the upper side of the top housing space in the edge image and divides the calculated length by the reference length to calculate the height of the rack 10 (the height of housing spaces, unit: U).

The LED detecting section 144 detects changes in multiple edge images corresponding to data of multiple chronologically-ordered images in a predetermined period. The LED detecting section 144 detects in an edge image (the first edge image among the multiple edge images in a predetermined period, for example), a region corresponding to the LED which blinks in accordance with the instruction to blink an LED from the LED blink controller 130. In the following description, the outline surrounding the region detected by the LED detecting section 144 is sometimes referred to as an LED outline.

The mounting position specifying section 145 specifies a rectangle corresponding to the outer edge of the rack-mount device 300 including the LED outline in the edge image. The mounting position specifying section 145 specifies the mounting position of the rack-mount device 300 in the rack 10 based on the position (the position in the image of the rack 10) of the specified rectangle in the edge image. The mounting position specifying section 145 registers the device information received by the data communication section 120 in the device management information stored in the memory 110 in association with the specified mounting position.

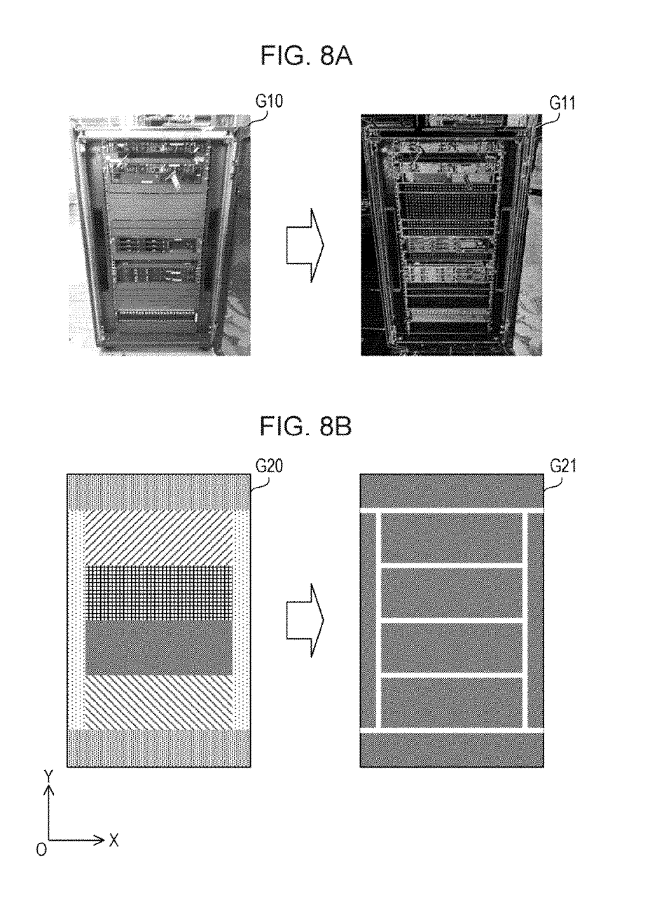

FIGS. 8A and 8B are diagrams illustrating an example of generating the edge image of the second embodiment. FIG. 8A illustrates a photographed camera image G10 and an edge image G11 generated by performing edge enhancement for the camera image G10. FIG. 8B illustrates a camera image G20 schematically illustrating the camera image G10 and an edge image G21 generated by performing edge enhancement for the camera image G20. The direction from left to right in the drawing is referred to as an X-axis direction, and the direction from the bottom to the top is referred to as a Y-axis direction. The X-axis direction is also referred to as a rack width direction or a lateral direction. The Y-axis direction is also referred to as a height direction or a vertical direction. The length in the X-axis direction is sometimes referred to as a lateral length or a width. The length of in the Y-axis direction is sometimes referred to as a vertical length. The quantity of units (U) corresponding to the vertical length is also referred to as a height.

The edge enhancement process creates another image in which the boundaries (edges) between contrasting colors in the image is emphasized. In the edge images G11 and G12, for example, the boundaries between contrasting colors are illustrated in white, and the other regions are illustrated in colors other than white. The boundaries between the images of the rack-mount devices in the camera images G10 and G20, lines representing the outlines of the rack sidewalls along the rack height, and lines representing the outlines of the top and bottom plates of the rack are illustrated by white lines in the edge images G11 and G21. By using the edge images G11 and G21, the image analysis section 140 easily detects rectangles corresponding to the outer edges of the rack-mount devices, the lines along the rack height, the lower side of the bottom housing space of the rack, the upper side of the top housing space, and the like. By acquiring the multiple chronologically-ordered edge images, the image analysis section 140 easily detects the operation of the rack-mount device such as blinking of an LED based on changes in the edge images.

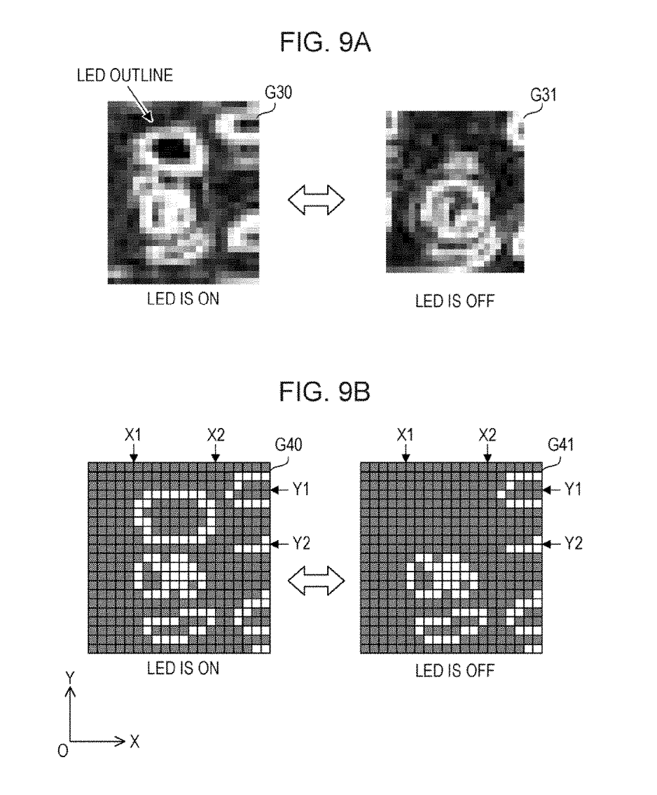

FIGS. 9A and 9B are diagrams illustrating examples of detecting LED outlines in the edge images of the second embodiment. FIG. 9A illustrates an edge image G30 created from a camera image of an LED turned on and an edge image G31 created from a camera image of the same LED turned off. FIG. 9B illustrates an edge image G40 (a turned-on LED) and an edge image G41 (a turned-off LED) schematically illustrating the edge images G30 and G31, respectively. The direction from left to right in the drawing is referred to as an X-axis direction, and the direction from the bottom to the top is referred to as a Y-axis direction.

As described in FIGS. 8A and 8B, boundaries between multiple regions in an image are emphasized in the edge image. When the LED is on, brightness or particular color in the light emitting region is stronger than in the surrounding region, so that the boundaries between the both regions are emphasized. On the other hand, when the LED is turned off, the boundaries between the same region and the surrounding region are weaker than when the LED is on.

When multiple edge images corresponding to multiple chronologically-ordered camera images of a blinking LED are observed, the edge image of the LED turned on includes an LED outline surrounded by a white line, for example, while the edge image of the LED turned off does not include the LED outline. The LED detecting section 144 detects the LED outline corresponding to the LED blinking in a predetermined cycle based on the multiple edge images. In the example of FIG. 9B, the LED detecting section 144 specifies a region indicated by X1 to X2 in the X axis and Y1 to Y2 in the Y axis as the region of the LED and detects the region surrounding the specified region as the LED outline.

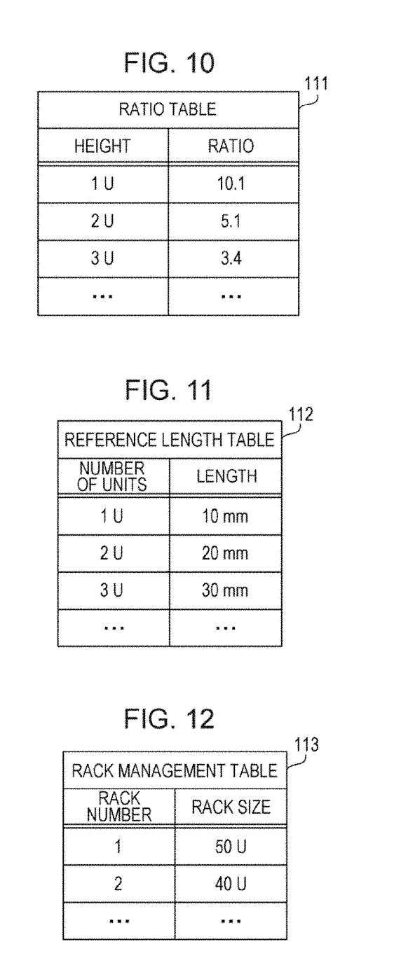

FIG. 10 is a diagram illustrating an example of the ratio table of the second embodiment. The ratio table 111 is ratio information and is previously stored in the memory 110. The ratio table 111 includes height and ratio items.

For each height item, the height of a rack-mount device is registered. The unit of height is the quantity of units (U). For each ratio item, the ratio of lateral size to vertical size (lateral size/vertical size) of the rack-mount device in the front view is registered.

For example, information of a height of 1U and a ratio of 10.1 is registered in the ratio table 111. This indicates that a rack-mount device having a height of 1U has a ratio of lateral size to vertical size of 10.1. In the ratio table 111, other ratios are similarly registered corresponding to other heights such as 2U and 3U.

FIG. 11 is a diagram illustrating an example of the reference length table of the second embodiment. The reference length table 112 is stored in the memory 110. The reference length table 112 includes number-of-unit and length items.

For each number-of-unit item, the quantity of units indicating a height is registered. For each length item, length on an edge image (or length on a camera image) is registered. In the reference length table 112, information of the quantity of units of 1U and a length of 10 mm is registered, for example. This indicates that the height corresponding to the quantity of units 1U corresponds to a length of 10 mm on an edge image. In the reference length table 112, lengths for other numbers of units (2U, 3U, . . . ) are similarly registered.

FIG. 12 is a diagram illustrating an example of the rack management table of the second embodiment. The rack management table 113 is rack management information and is stored in the memory 110. The rack management table 113 includes a rack number item and a rack size item.

For the rack number item, the rack number indicating a rack is registered. For the rack size item, the entire height of housing spaces of the rack is registered. In the rack management table 113, information of a rack number of 1 and a rack size of 50U is registered. This indicates that the rack indicated by a rack number of 1 has a rack size of 50U. A rack having a rack size of 50U is capable of housing 50 devices with a size of 1U, for example. Alternatively, a rack having a rack size of 50U is capable of housing 25 devices with a size of 2U (a rack houses rack-mount devices with multiple different sizes in some cases).

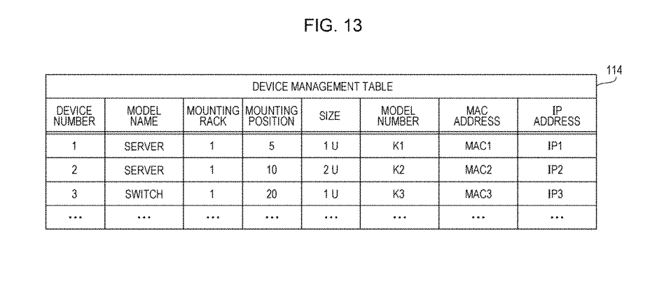

FIG. 13 is a diagram illustrating an example of a device management table of the second embodiment. The device management table 114 is device management information and is stored in the memory 110. The device management table 114 includes device number, model name, mounting rack, mounting position, size, model number, MAC address, and IP address items.

For the device number item, a device number to identify a rack-mount device is registered. For the model name item, the name indicating the type of the rack-mount device is registered. For the mounting rack item, the rack number of the rack where the rack-mount device is mounted is registered. For the mounting position item, the position number indicating the mounting position in the rack is registered. For the size item, the size corresponding to the height of the rack-mount device is registered. For the model number item, the model number of the rack-mount device is registered. For the media access control (MAC) address item, the MAC address of the rack-mount device is registered. For the IP address item, the IP address of the rack-mount device is registered.

An example of information registered in the device management table 114 includes a device number of “1”, a model name of “server”, a mounting rack of “1”, a mounting position of “5”, a size of “1U”, a model number of “K1”, a MAC address of “MAC1”, and an IP address of “IP1”.

This information indicates that a rack-mount device with a device number of “1” has a model name of “server” and is mounted in a housing space corresponding to a mounting position of “5” in the rack having a rack number of “1”. The rack-mount device with a device number of “1” has a height size of 1U, a model number of “K1”, a MAC address of “MAC1”, and an IP address of “IP1”.

As the device information is collected, records are added to the device management table 114. If the device information is not collected from any rack-mount device, the device management table 114 does not include any record.

As described above, the management server 100 previously stores in the memory 110, a list of IP addresses of rack-mount devices to be managed for each rack number as different information from the device management table 114.

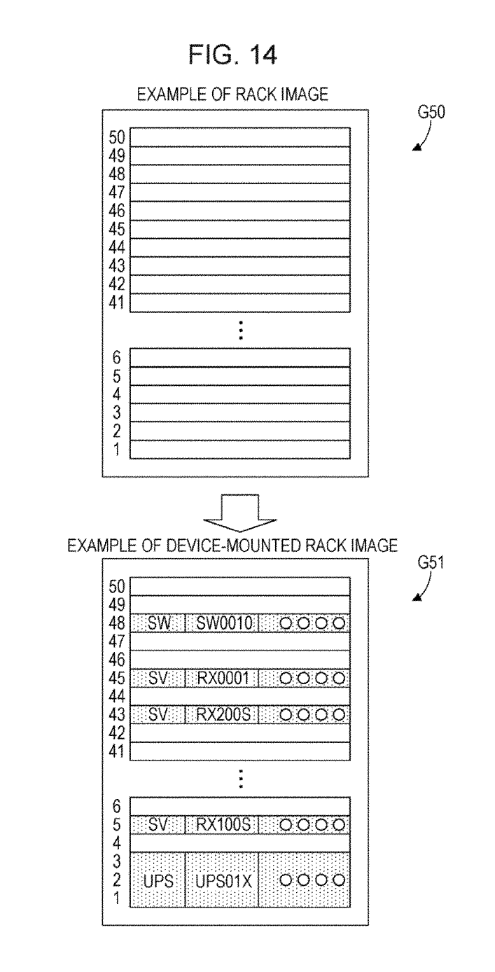

FIG. 14 is a diagram illustrating an example of output images of the second embodiment. The data communication section 120 transmits to the terminal device 200, image data representing rack-mount devices in a rack (the rack 10, for example) based on the device management table 114 stored in the memory 110. The terminal device 200 displays the image of the rack and rack-mount devices in the rack using the display 205a based on the image data received from the management server 100.

The data communication section 120 first transmits image data of a rack image G50 to the terminal device 200. The rack image G50 is an image representing the state where no rack-mount device is mounted in the rack 10. In the rack image G50, all the housing spaces of the rack 10, which have a total height of 50 U, are vacant. Each housing space is given a position number. The position numbers 1, 2, 3, . . . 50 are sequentially given to the respective housing spaces in the rack 10 beginning with the bottom housing space to the top.

Secondly, the data communication section 120 transmits image data of a rack-device image G51 to the terminal device 200. The rack-device image G51 is an image representing the state where rack-mount devices are mounted in the rack 10. The rack-device image G51 includes an image representing a part of the collected device information of rack-mount devices the device information of which is already collected, at the mounting position thereof. The device information includes the model name, model number, and current state such as on/off of the power supply, for example.

Next, a description is given of the processing procedure by the management server 100 configured as described above. In the example described below, the management server 100 mainly manages the rack 10 and rack-mount device 300. The management server 100 manages other racks such as the racks 10a and 10b and other rack-mount devices such as the rack-mount device 300a in a similar manner.

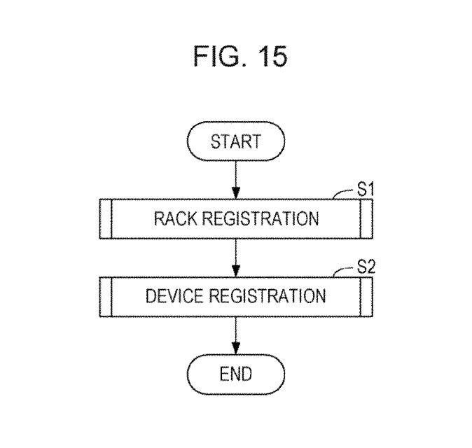

FIG. 15 is a flowchart illustrating a process example of a management server of the second embodiment. Hereinafter, a description is given of the process illustrated in FIG. 15 along step numbers. (S1) The management server 100 executes a process of rack registration. Specifically, the data communication section 120 receives image data of a still picture (or a video) of the front of the rack 10 from the terminal device 200. The image analysis section 140 analyses the received image data to calculate the height of the rack 10 (unit: U). The process is described in detail later.

(S2) The management server 100 executes a process of device registration. Specifically, the data communication section 120 transmits to the selected IP address as the destination, a request to transmit device information and receives device information as the response to the request to transmit. The LED blink controller 130 transmits an instruction to blink an LED in a particular cycle to the selected IP address as the destination. The data communication section 120 then receives image data of the video of the front of the rack 10 from the terminal device 200. The image analysis section 140 analyses the received image data to specify a rack-mount device which has transmitted the device information and specify the mounting position of the mount-rack device. The image analysis section 140 then registers the device information and mounting position in the device management table 114 in relation to each other. The process is described later in detail.

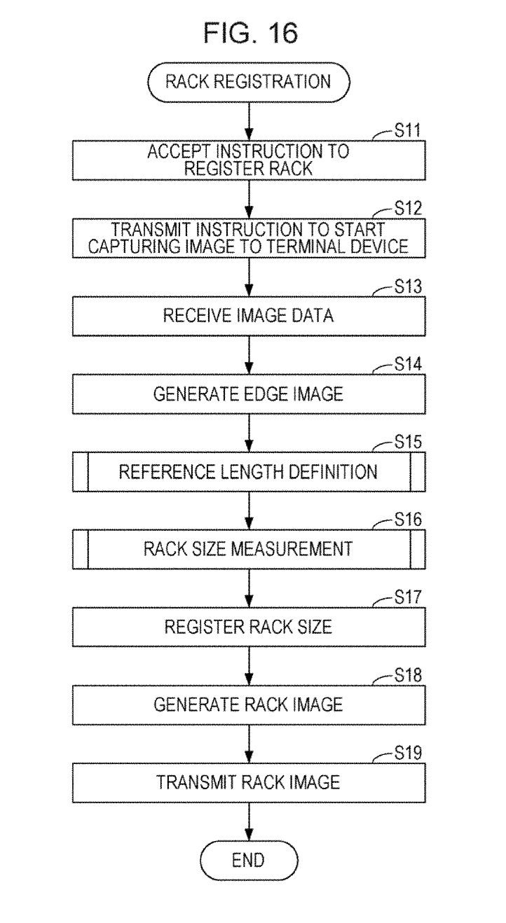

FIG. 16 is a flowchart illustrating an example of rack registration of the second embodiment. Hereinafter, the process illustrated in FIG. 16 is described along step numbers. The process below corresponds to step S1 in FIG. 15.

(S11) The data communication section 120 accepts an instruction to register a rack from the terminal device 200. The user U10 operates the input device 206a with the camera 204 directed to the front of the rack 10 to input the start of rack registration in the terminal device 200 together with the rack number (“1”, for example) of the rack 10. The terminal device 200 then transmits an instruction to register a rack including the rack number of the rack 10, to the management server 100. The data communication section 120 receives the transmitted instruction to register a rack.

(S12) The data communication section 120 transmits an instruction to start capturing an image (taking a still picture or shooting a video) of the front of the rack 10 to the terminal device 200 in accordance with the instruction to register a rack. Upon receiving the instruction to start capturing an image, the terminal device 200 starts capturing an image of the rack 10 with the camera 204. The terminal device 200 transmits to the management server 100, image data of the rack 10 generated by capturing an image of the rack 10.

(S13) The data communication section 120 receives the image data from the terminal device 200 and stores the image data in the memory 110. (S14) The edge image generating section 141 generates an edge image based on the image data received in the step S13.

(S15) The reference length defining section 142 creates the reference length table 112 based on the edge image generated in the step S14 and the ratio table 111 stored in the memory 110. The process is described in detail later.

(S16) The rack height measuring section 143 measures the rack size (the height of the rack) based on the edge image generated in the step S14 and the reference length table 112 stored in the memory 110. The process is described in detail later.

(S17) The rack height measuring section 143 registers the rack size (the height of the rack) measured in the step S16, in the rack management table 113 in association with the rack number (“1”, for example).

(S18) The data communication section 120 generates the rack image G50 based on the height of the rack having the rack number (“1”, for example) currently registered in the rack management table 113. (S19) The data communication section 120 transmits the rack image G50 to the terminal device 200.

Upon receiving the rack image G50, the terminal device 200 displays the rack image G50 on the display 205a to provide the same to the user U10. The management server 100 accepts the input of the rack number of the rack to be currently registered from the user U10 in the example of the step S11 but may be configured to acquire the rack number with another method. For example, a two-dimensional marker having a predetermined pattern corresponding to the rack number may be attached to the front of the rack 10 in advance. The management server 100 detects the two-dimensional marker included in the image data received in the step S13 and specifies the rack number of the rack in the captured image, based on the detected two-dimensional marker. Alternatively, the management server 100 may previously hold information of rack numbers in relation to rack positions. The management server 100 receives position information (the position in front of the rack) of the terminal device 200 together with the instruction to register a rack and specifies the rack number of the rack of the captured image, based on the position information of the terminal device 200 and the information of the rack number corresponding to the rack position. The input of the identification information of the rack by the user U10 may be automated for labor-saving of the user U10.

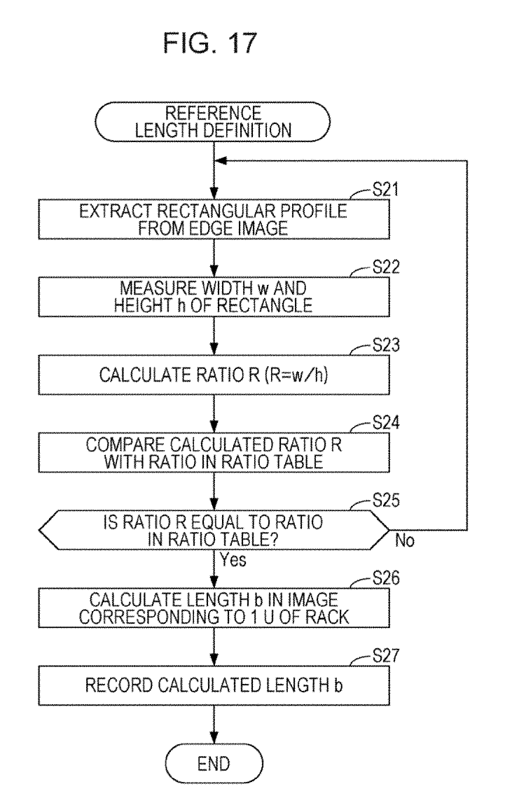

FIG. 17 is a flowchart illustrating an example of reference length definition of the second embodiment. Hereinafter, the process illustrated in FIG. 17 is described along the step numbers. The process below corresponds to the step S15 of FIG. 16.

(S21) The reference length defining section 142 extracts a rectangular profile from the edge image generated by the edge image generating section 141. (S22) The reference length defining section 142 measures in the edge image, width (lateral length) w and height h of the rectangle extracted in the step S21.

(S23) The reference length defining section 142 calculates a ratio R (=w/h) of the width w to height h of the rectangle which are measured in the step S22. (S24) The reference length defining section 142 compares the ratio R calculated in the step S24 with the ratios registered in the ratio table 111.

(S25) The reference length defining section 142 determines whether the ratio R equals to any one of the ratios registered in the ratio table 111 with a predetermined accuracy. When the ratio R equals to any one of the ratios registered in the ratio table 111 with the predetermined accuracy, the process proceeds to step S26. When the ratio R does not equal to any one of the ratios registered in the ratio table 111 with the predetermined accuracy, the process proceeds to the step S21 to extract another rectangular profile from the edge image. Herein, “the ratio R equals to any one of the ratios registered in the ratio table 111 with the predetermined accuracy” means that the difference between the ratio R and a ratio registered in the ratio table 111 is within about 3% of the ratio R as an error, for example. The margin of error may be determined depending on the operation.

(S26) The reference length defining section 142 calculates a length b in an image that corresponds to 1U of the rack 10. Specifically, the reference definition section 142 acquires height n (U) (n is an integer not less than 1) corresponding to the ratio which is determined to equal to the ratio R in the step S25, from the ratio table 111. The reference length defining section 142 calculates the length b as b=h/n.

(S27) The reference length defining section 142 creates the reference length table 112 and records the correspondence relationship between the quantity of units and height. Specifically, the reference length defining section 142 associates 1 (U) with b. The reference length defining section 142 associates 2 (U) with 2b. The reference length defining section 142 thus registers height-direction lengths corresponding to possible heights of rack-mount devices, in the reference length table 112.

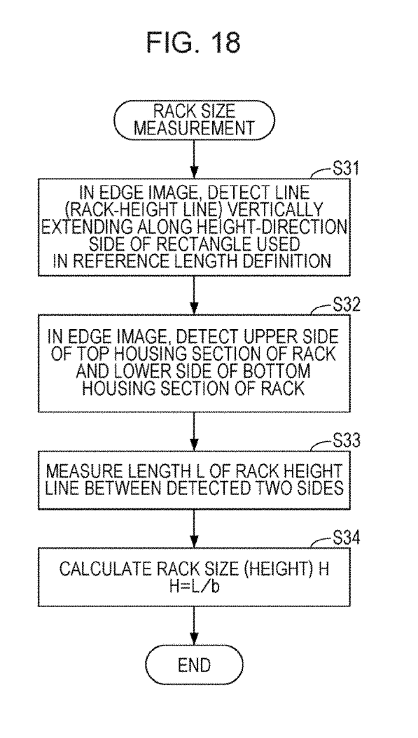

FIG. 18 is a flowchart illustrating an example of rack size measurement of the second embodiment. Hereinafter, the process illustrated in FIG. 18 is described along step numbers. The procedure below corresponds to the step S16 of FIG. 16.

(S31) The rack height measuring section 143 detects a rack height line in the edge image. The rack height line refers to a line vertically extending along a side, in the height direction, of the rectangle used in the process of reference length definition. (S32) In the edge image, the rack height measuring section 143 detects the upper side of the top housing section (housing space) in the image of the rack 10 and the lower side of the bottom housing section.

(S33) The rack height measuring section 143 measures length L of the rack height line between the two sides detected in the step S32. (S34) The rack height measuring section 143 calculates the rack size (height) H. Specifically, the rack height measuring section 143 calculates H=L/b.

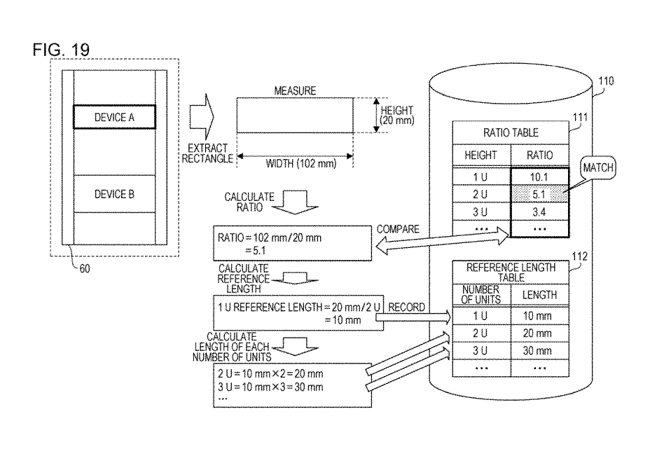

FIG. 19 is a diagram illustrating an example of reference length definition in the process of rack registration of the second embodiment. The image analysis section 140 acquires the camera image created by the terminal device 200 and generates an edge image 60 from the camera image. The edge image 60 includes the entire view of the front of the rack 10. The edge image 60 is an edge image corresponding to the camera image of the rack 10 that houses two rack-mount devices herein. In the edge image 60, lines representing edges are illustrated in black, and the other region is illustrated in white unlike FIGS. 8A and 8B and FIGS. 9A and 9B. In FIG. 19, labels of “Device A” and “Device B” are attached to images corresponding to the two rack-mount devices for convenience. However, the edge image 60 does not include images corresponding to the labels.

The image analysis section 140 extracts a rectangle corresponding to “Device A” from the edge image 60, for example. The image analysis section 140 measures the width and height of the rectangle to obtain a width of 102 mm (=w) and a height of 20 mm (=h). The image analysis section 140 calculates the ratio as w/h=102 mm/20 mm=5.1.

The image analysis section 140 compares the calculated ratio “5.1” with each ratio registered in the ratio table 111. The image analysis section 140 determines that the calculated ratio “5.1” matches the ratio “5.1” registered in the ratio table 111. The extracted rectangle is a rectangle corresponding to any one of the rack-mount devices mounted in the rack 10. The image analysis section 140 determines whether the extracted rectangle is a rack-mount device by using the ratio table 111. When determining that the extracted rectangle corresponds to one of the rack-mount devices, the image analysis section 140 acquires the height of 2 (=n) U corresponding to the ratio “5.1” from the ratio table 111.

The image analysis section 140 calculates 1U reference length (b described above) which is the length corresponding to 1U on an edge image as: 1U reference length=h/n=20 mm/2U=10 mm. The image analysis section 140 registers the calculated 1U reference length “10 mm” in association with the number of unit “1U” in the reference length table 112.

The image analysis section 140 calculates the length of each quantity of units (2U, 3U, . . . ) possible as rack-mount devices. Specifically, the image analysis section 140 calculates length corresponding to each quantity of units by multiplying the 1U reference length by the quantity of units. When the quantity of units is 2U, the 1U reference length is multiplied by 2, and when the quantity of units is 3U, the 1U reference length is multiplied by 3. In the example of FIG. 19, the image analysis section 140 calculates the length corresponding to the quantity of units 2U as: 10 mm×2=20 mm and registers the calculated length in the reference length table 112. The image analysis section 140 calculates the length corresponding to the quantity of units 3U as: 10 mm×3=30 mm and registers the calculated length in the reference length table 112. The image analysis section 140 calculates lengths corresponding to the numbers of units larger than 3U in a similar manner.

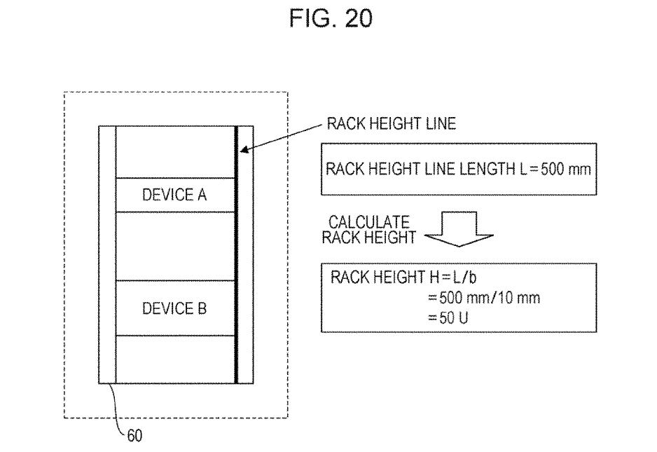

FIG. 20 is a diagram illustrating an example of rack size measurement of the second embodiment. The image analysis section 140 detects a rack height line along the height-direction line segment of the rectangle corresponding to the label of “Device A” in the edge image 60, for example. The image analysis section 140 assumes that the upper end of the rack height line intersects with a line corresponding to the upper side of the top housing space in the rack. The image analysis section 140 assumes that the lower end of the rack height line intersects with a line corresponding to the lower side of the bottom housing space in the rack. The image analysis section 140 measures the length L of the rack height line in the edge image 60. In the example of FIG. 20, the image analysis section 140 acquires L=500 mm.

The image analysis section 140 calculates the rack height H based on L. Specifically, the image analysis section 140 obtains H=L/b=500 mm/10 mm=50U. The image analysis section 140 calculates the number (“50U” herein) of housing sections in the rack 10 based on the length (extending in the rack-width direction) of the rectangle corresponding to a device mounted in the rack 10 and the height-direction length of the entire space accommodating section of the rack 10 in the edge image.

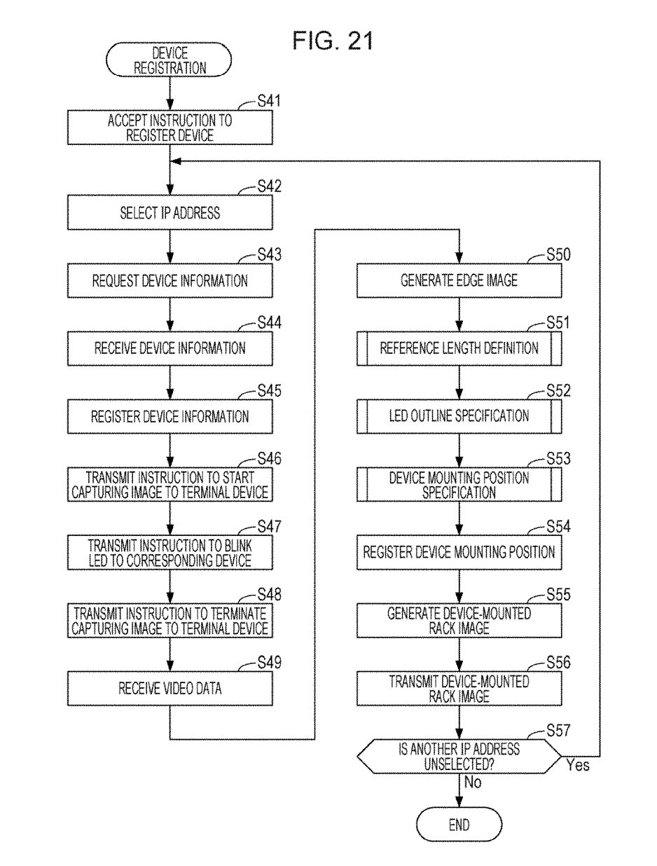

The management server 100 thus obtains the size of the rack 10 of interest. Next, the procedure of device registration by the management server 100 is described. FIG. 21 is a flowchart illustrating an example of device registration of the second embodiment. Hereinafter, the process illustrated in FIG. 21 is described along step numbers. The procedure below corresponds to the step S2 in FIG. 15.

(S41) The data communication section 120 accepts an instruction to register devices from the terminal device 200. For example, the user U10 operates the input device 206a with the camera 204 of the terminal device 200 directed to the front of the rack 10 and inputs the start of device registration in the terminal device 200 together with the rack number (“1”, for example) of the rack 10. The terminal device 200 transmits an instruction to register devices including the rack number of the rack 10 to the management sever 100. The data communication section 120 receives the transmitted instruction to register devices.

(S42) The data communication section 120 acquires multiple IP addresses corresponding to the rack number (“1”, for example) of the rack which is a current target for device registration with reference to the list of IP addresses of the rack-mount devices for each rack number stored in the memory 110. The data communication section 120 selects an IP address (the IP address of the rack-mount device 300, for example) from the multiple acquired IP addresses.

(S43) The data communication section 120 transmits a request to transmit device information, to the selected IP address as the destination. In other words, the data communication section 120 requests device information. The request to transmit device information reaches the rack-mount device 300. Upon receiving the request to transmit, the rack-mount device 300 transmits the device information of the rack-mount device 300 as the response. The device information transmitted by the rack-mount device 300 does not include information of the mounting position of the rack-mount device 300.

(S44) The data communication section 120 receives the device information of the rack-mount device 300. (S45) The data communication section 120 creates a record of the received device information and registers the created record in the device management table 114 (the record does not include information on the mounting position when the record is created).

(S46) The data communication section 120 transmits to the terminal device 200, an instruction to start shooting a video of the front of the rack 10. Upon receiving the instruction to start shooting a video, the terminal device 200 starts shooting a video of the rack 10 with the camera 204.

(S47) The LED blink controller 130 transmits an instruction to blink an LED to the IP address selected in the step S42 as the destination. The instruction to blink an LED includes a blinking cycle and the quantity of blinks. The instruction to blink an LED reaches the rack-mount device 300. The rack-mount device 300 causes an LED 306 to blink with the blinking cycle and the quantity of blinks which are specified by the instruction to blink an LED. The blinking operation of the LED 306 is recorded as a video with the terminal device 200.

(S48) The LED blinking controller 130 notifies the data communication section 120 of the elapsing of the blinking period when detecting the elapse of the blinking period after transmitting the instruction to blink an LED. The blinking period is determined depending on the blinking cycle and the quantity of blinks. The data communication section 120 then transmits an instruction to terminate shooting a video to the terminal device 200. The terminal device 200 receives the instruction to terminate shooting a video and stops shooting the video in accordance with the instruction to terminate shooting a video. The terminal device 200 transmits to the management server 100, video data generated by taking the video.

(S49) The data communication section 120 receives the video data and stores the received video data in the memory 110. (S50) The edge image generating section 141 obtains multiple data sets of chronologically-ordered images based on the video data stored in the memory 110. The edge image generating section 141 generates an edge image for each of the multiple data sets of chronologically-ordered images and stores the multiple generated edge images in the memory 110.

(S51) Based on any one of the edge images generated in the step S50 (the first edge image in the chronological order, for example) and the ratio table 111 stored in the memory 110, the reference length defining section 142 calculates the reference length b corresponding to 1U in the edge image. The reference length defining section 142 registers the calculated reference length b in the reference length table 112. The specific procedure of the process is the same as the procedure illustrated in FIG. 17. The reference length defining section 142 deletes all the existing records registered in the reference length defining section 142 before executing the step S51.

(S52) The LED detecting section 144 detects changes in the multiple edge images to specify an LED outline. The process is described later in detail. (S53) The mounting position specifying section 145 uses the detected result of the LED outline by the LED detecting section 144 to specify the mounting position of rack-mount device 300 in the rack 10. The process is described later in detail.

(S54) The mounting position specifying section 145 registers the specified mounting position in the record created in the step S45 in the device management table 114. (S55) Based on the device management table 114, the data communication section 120 generates a device-mounted rack image (the device-mounted rack image G51, for example) representing the state where the rack-mount device 300 is mounted in the rack 10. In the device-mounted rack image G51, another rack-mount device in the rack 10 is already detected in addition to the rack-mount device 300. Each time the data communication section 120 newly acquires the device information and mounting position, the data communication section 120 adds an image representing the corresponding rack-mount device to the device-mounted rack image G51.

(S56) The data communication section 120 transmits the generated device-mounted rack image G51 to the terminal device 200. Upon receiving the device-mounted rack image G51, the terminal device 200 displays the device-mounted rack image G51 in the display 205a to provide the device-mounted rack image G51 to the user U10.

(S57) The data communication section 120 determines whether any one of the IP addresses of the rack-mount devices corresponding to the rack number accepted together with the instruction to register devices in the step S41 is unselected. When any one of the IP addresses is unselected, the process proceeds to the step S42. When all the IP addresses are already selected, that is, the device information for all the IP addresses corresponding to the rack number of interest are already collected, the process is terminated. In such a manner, the management server 100 collects the device information and mounting position for each of the multiple rack-mount devices mounted in the rack 10 sequentially like the rack-mount devices 300 and 300a.

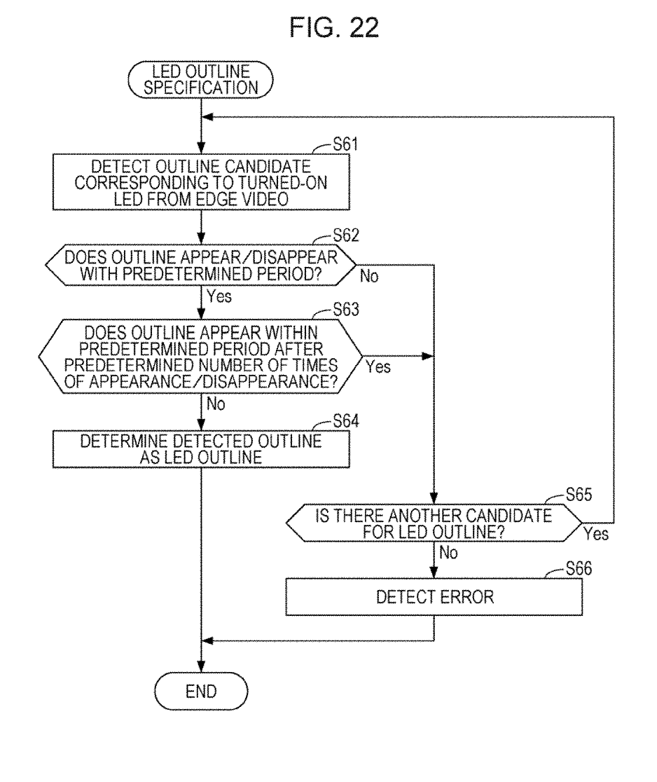

FIG. 22 is a flowchart illustrating an example of LED outline specification of the second embodiment. Hereinafter, the process illustrated in FIG. 22 is described along step numbers. The procedure illustrated below corresponds to the step S52 in FIG. 21.

(S61) The LED detecting section 144 detects a candidate for the outline (LED outline) corresponding to the turned-on LED from the edge video (multiple chronologically-ordered edge images generated in the step S50). (S62) The LED detecting section 144 determines whether the detected outline candidate appears and disappears in the edge video in a predetermined cycle instructed by the instruction to blink an LED. When the detected outline candidate appears and disappears in the predetermined cycle instructed by the instruction to blink an LED, the process proceeds to step S63. When the detected outline candidate does not appear and disappear in the predetermined cycle, the process proceeds to step S65. In the latter case, it is determined that the candidate for the LED outline does not correspond to the LED which blinks in accordance with the instruction to blink an LED (the candidate of interest corresponds to an LED different from the LED 306, for example). With an example of the predetermined cycle, the LED is turned on for one second and blinks for one second.

(S63) The LED detecting section 144 determines whether the outline candidate appears in the edge video within a predetermined period after the outline candidate appears and disappears for the predetermined quantity of times. When the outline candidate does not appear within the predetermined period after the outline candidate appears and disappears for the predetermined quantity of times, the process proceeds to step S64. When the outline candidate appears within the predetermined period after the outline candidate appears and disappears for the predetermined quantity of times, the process proceeds to step S65. In the latter case, it is determined that the candidate for the LED outline does not correspond to the LED which blinks in accordance with the instruction to blink an LED (and corresponds to an LED different from the LED 306, for example). The quantity of times (the quantity of times that the outline candidate appears and disappears) is five, and the predetermined period of time is one second, for example.

(S64) The LED detecting section 144 determines that the outline candidate (the candidate for the LED outline detected in the step S61) is the LED outline corresponding to the LED to be detected (the LED 306, for example).

(S65) The LED detecting section 144 determines whether another candidate for the LED outline is included in the edge video. When another candidate for the LED outline is included in the edge video, the process proceeds to step S61 (to detect the region of another candidate for the LED outline). When another candidate for the LED outline is not included in the edge video, the process proceeds to step S66.

(S66) The LED detecting section 144 detects as an error that the LED outline is not specified in the edge video. The data communication section 120 transmits information on the detected error to the terminal device 200, for example. In this case, the process of the step S53 and following steps in FIG. 21 is not performed, and the image analysis section 140 terminates the process of device registration. Upon receiving the information on the detected error, the terminal device 200 provides the details of the error to the user U10. This prompts the user U to perform the operation for device registration over again.

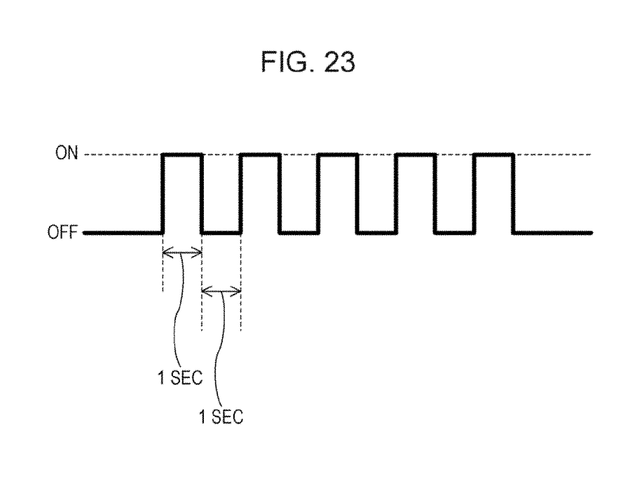

A description is given of a specific example of blinking of the LED 306 in accordance with the instruction to blink an LED, which is also illustrated in the step S62. FIG. 23 is a diagram illustrating an example of blinking of an LED of the second embodiment. The LED blink controller 130 blinks the LED 306 of the rack-mount device 300 as follows, for example. The time when the LED 306 is kept turned on is set to 1 second while the time when the LED 306 is kept turned off is set to 1 second. The turning on and off of the LED 306 is performed repeatedly with a duration of 1 second. As an example, the quantity of repetitions is five. The five repetitions mean that the 2-second time zone composed of a pair of on and off periods of the LED 306 is repeatedly produced for five times. After the five repetitions, the LED 306 is kept turned off (blinking is stopped).

The duration of blinking by the LED 306 is set to such a duration that enables light emission of the LED 306 to be distinguished from light emission of the other LEDs used in the other applications such as notification of power supply status, notification of error, and notification of data access, for example.

As illustrated in FIG. 22, by performing the determination in the steps S62 and S63, the LED detecting section 144 distinguishes the LED outline corresponding to the LED to be detected (the LED 306, for example) from outlines corresponding to LEDs used in the other applications. The LED outline corresponding to the LED to be detected is therefore properly detected.

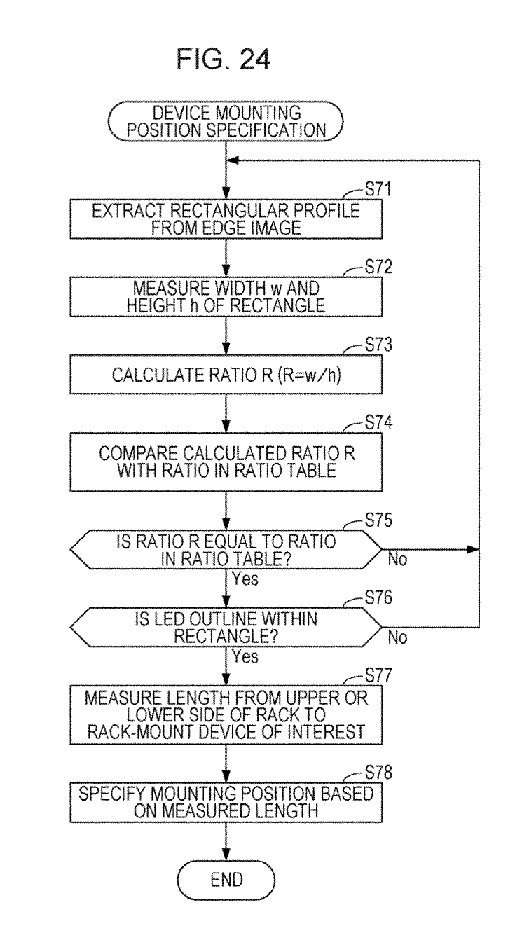

FIG. 24 is a flowchart illustrating an example of device mounting position specification of the second embodiment. Hereinafter, the process illustrated in FIG. 24 is described along step numbers. The procedure illustrated below corresponds to the step S53 of FIG. 21.

(S71) The mounting position specifying section 145 extracts a rectangle from the first one of the chronologically-ordered edge images of the edge video generated by the edge image generating section 141. (S72) The mounting position specifying section 145 measures in the edge image, the width (lateral length) w and height h of the rectangle extracted in the step S71.

(S73) The mounting position specifying section 145 calculates the ratio R=(w/h) of the width w and height h of the rectangle measured in the step S72. (S74) The mounting position specifying section 145 compares the ratio R calculated in the step S73 with each of the ratios registered in the ratio table 111.

(S75) The mounting position specifying section 145 determines whether the ratio R matches any one of the ratios registered in the ratio table 111 with the predetermined accuracy. When the ratio R matches any one of the ratios registered in the ratio table 111 with the predetermined accuracy, the process proceeds to step S76. When the ratio R does not match any one of the ratios registered in the ratio table 111 with the predetermined accuracy, the process proceeds to the step S71 (to extract another rectangle from the edge image). Herein, the “predetermined accuracy” is considered in the same manner as the step S25 in FIG. 17.

(S76) The mounting position specifying section 145 determines whether the LED outline specified in the step S52 is within the rectangle extracted in the step S71. When the LED outline specified in the step S52 is within the rectangle extracted in the step S71, the process proceeds to step S77. When the LED outline specified in the step S52 is not within the rectangle extracted in the step S71, the process proceeds to the step S71 (to extract another rectangle from the edge image).

(S77) The mounting position specifying section 145 measures in the edge image, length h1 from the rack-mount device of interest to the upper side (the upper side of the top housing space) or the lower side (the lower side of the bottom housing space) of the rack. The mounting position specifying section 145 measures in the edge image, the distance between the upper side of the rack and the lower side of the rectangle corresponding to the rack-mount device of interest as the length h1, for example.

(S78) Based on the measured length h1, the mounting position specifying section 145 specifies the mounting position of the rack-mount device 300. When the length h1 is the distance between the upper side of the rack and the lower side of the rectangle corresponding to the rack-mount device 300 of interest, for example, the mounting position of the rack-mount device 300 is calculated as 50−h1/b+1. Alternatively, when the length h1 is the distance between the lower side of the rack and the lower side of the rectangle corresponding to the rack-mount device 300 of interest, for example, the mounting position of the rack-mount device 300 is calculated as h1/b+1. Herein, the mounting position specifying section 145 uses the value calculated in the step S51 of FIG. 21 as the reference length b in the calculation of the step S78. The process is then terminated.

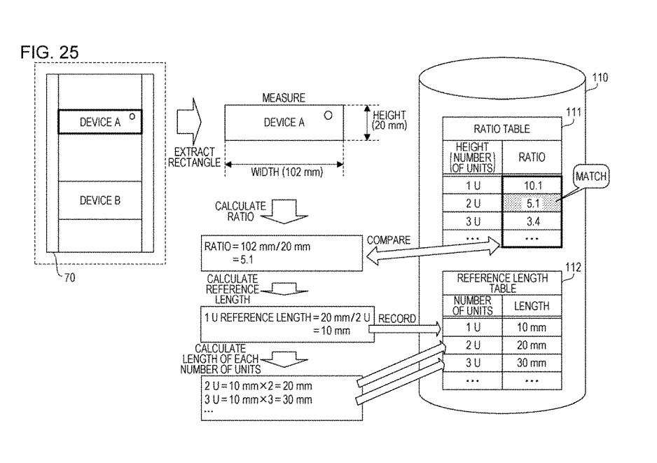

FIG. 25 is a diagram illustrating an example of reference length definition in the process of device mounting position specification of the second embodiment. The reference length defining section 142 defines the reference length of the rack 10 at device registration as well as at rack registration as illustrated in FIG. 21. The reason therefor is because the position of the terminal device 200 relative to the rack 10 may differ between two timings of rack registration and device registration.

When the distance between the rack 10 and terminal device 200 differs, for example, the reference length b in the taken image may also differ. The reference length defining section 142 therefore recreates the reference length table 112 at device registration. The specific method of recreating the reference length table 112 is the same as that illustrated in FIGS. 17 and 19.

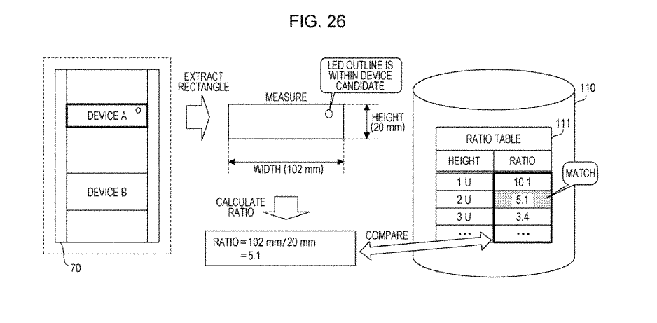

FIG. 26 is a diagram illustrating an example of device mounting position specification of the second embodiment. The image analysis section 140 acquires a camera image (video) generated by the terminal device 200 and generates an edge image 70 from the camera image (for example, the first one of the chronological camera images). The edge image 70 includes the entire front view of the rack 10. The edge image 70 is an edge image corresponding to the camera image of the rack 10 with two devices mounted. Unlike FIGS. 8A and 8B and FIGS. 9A and 9B, lines representing the edges are illustrated in black in the edge image 70, and the other region is illustrated in white. In FIG. 26, labels of “Device A” and “Device B” are attached to images corresponding to the two rack-mount devices for convenience. However, the edge image 70 does not include images corresponding to the labels.

The image analysis section 140 extracts a rectangle corresponding to “Device A” from the edge image 70, for example. The image analysis section 140 measures the width and height of the rectangle to obtain a width of 102 mm (=w) and a height of 20 mm (=h). The image analysis section 140 calculates the ratio as w/h=102 mm/20 mm=5.1. With reference to the ratio table 111, the ratio of 5.1 corresponds to a rectangle of a device with a height of 2U. The image analysis section 140 therefore determines that the extracted rectangle is a rectangle corresponding to any rack-mount device.

The image analysis section 140 detects that the LED outline is within the extracted rectangle. The image analysis section 140 then determines that the rectangle of interest is a rectangle corresponding to the rack-mount device which has transmitted the current device information and specifies the mounting position using the rectangle.

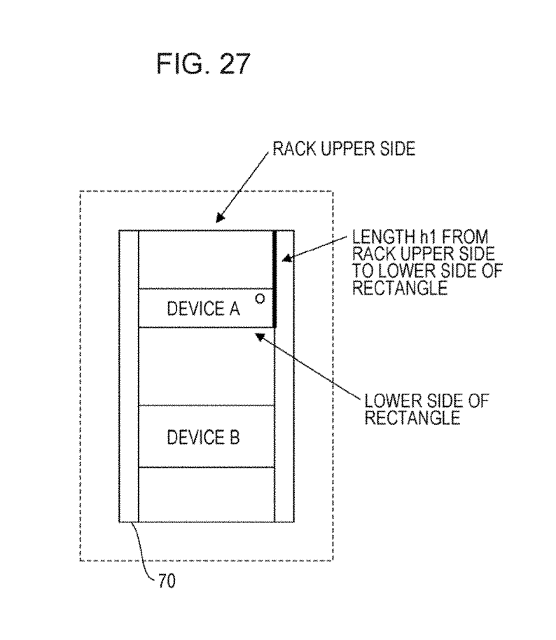

FIG. 27 is a diagram illustrating the device mounting position specification (continued) of the second embodiment. The image analysis section 140 measures in the edge image 70, the length h1 from the upper side of the rack to the lower side of the rectangle of “Device A”, for example. The image analysis section 140 calculates the mounting position of the rack-mount device as the mounting position=50−h1/b+1. The image analysis section 140 registers in the device management table 114, the calculated mounting position and the device information of the mounting device of interest in association with each other.

The method of calculating the length h1 is not limited to the method described above as an example. As the length h1, the image analysis section 140 may calculate the distance between the upper side of the rectangle of “Device A” and the upper side or lower side of the rack, for example. When the length h1 is the distance between the upper side of the rectangle of “Device A” and the upper side of the rack, for example, the mounting position is calculated as 50−h1/b. Alternatively, when the length h1 is the distance between the upper side of the rectangle of “Device A” and the lower side of the rack, for example, the mounting position is calculated as h1/b. When the height of the rack-mount device is not less than 2U, the rack-mount device occupies the quantity of housing spaces corresponding to the height from the specified mounting position. The image analysis section 140 thus specifies the mounting position based on the distance between a side of a rectangle corresponding to the rack-mount device, the side extending in the rack width direction, and a side of the top or bottom housing section (housing space) extending in the rack width direction.

With the management server 100, based on the ratio table 111 and the data of the image captured by the terminal device 200, the mounting positions of the rack-mount devices in the racks 10, 10a, and 10b are specified and are associated with the device information for management. Accordingly, the mounting positions of rack-mount devices are managed without special communication modules provided in the racks and rack-mount devices. This simplifies management of the mounting positions of the rack-mount devices mounted in each of the racks 10, 10a, and 10b. Moreover, the management server 100 assists the user U1 to efficiently manage information assets and implement labor-saving in operation management of the user U1 user U1.

### Third Embodiment

Hereinafter, a description is given of a third embodiment. The matters different from the above-described second embodiment are mainly described, and the same matters are not described.

In the second embodiment, the entire front view of the rack 10 does not fall within the field of view of the camera 204 sometimes when the terminal device 200 captures an image of the front view of the rack 10 at a certain distance from the rack 10. The third embodiment provides a function to cause the terminal device 200 to take multiple images of multiple divisions of the front view of the rack 10 and using the multiple images for rack registration and device registration.

Herein, the elements, such as the devices and hardware, of the operation management system of the third embodiment, are the same as those illustrated in the second embodiment. The elements of the operation management system of the third embodiment are indicated by the same names and reference numerals as those of the elements illustrated in the second embodiment. The management server 100 of the third embodiment also executes the procedures of rack registration and device registration illustrated in FIG. 15. The procedure of the third embodiment is partially different from those of the second embodiment.

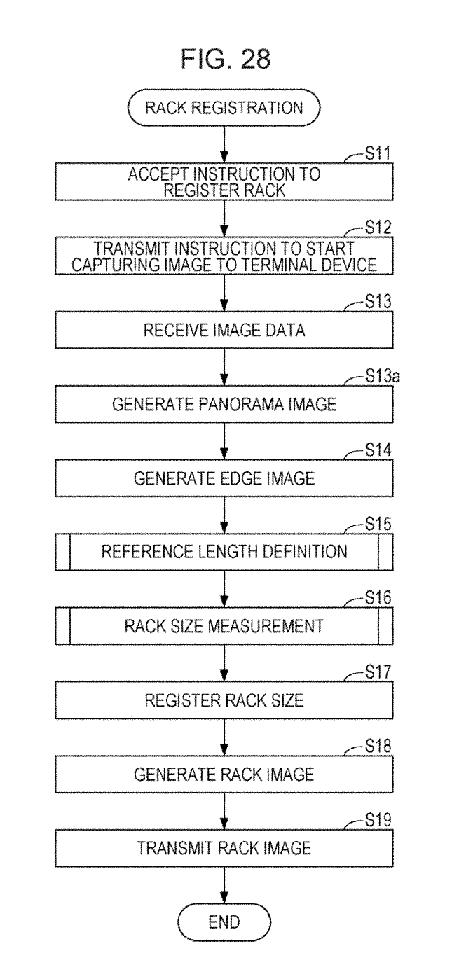

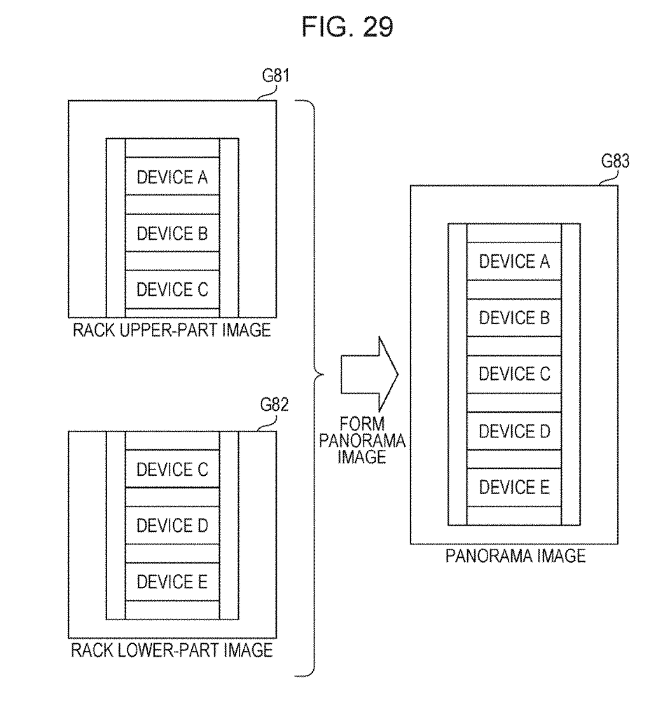

FIG. 28 is a flowchart illustrating an example of rack registration of the third embodiment. Hereinafter, the process illustrated in FIG. 28 is described along step numbers. The procedure illustrated in FIG. 28 is different from the procedure of rack registration illustrated in FIG. 16 in executing step S13a between the steps S13 and S14. The step S13a is mainly described below, and a description of the other steps is omitted. In the step S13, the management server 100 receives multiple images of multiple divisions of the front view of the rack 10 captured by the terminal device 200.

(S13a) The image analysis section 140 combines the multiple images to generate a panorama image. The process proceeds to step S14. In the process of the step S14 and subsequent steps, an edge image is generated based on the panorama image, and reference length definition and rack size measurement (rack height measurement) are performed.

FIG. 29 is a diagram illustrating an example of a panorama image of the third embodiment. The management server 100 receives images G81 and G82 captured by the terminal device 200, for example. The image G81 is a rack upper image which is an image of upper part of the front view of the rack 10. The image G82 is a rack lower image which is an image of lower part of the front view of the rack 10. The image analysis section 140 combines the images G81 and G82 to generate a panorama image G83. The method of combining multiple images into a panorama image may be an existing method.

The image analysis section 140 generates the edge image for the panorama image G83 and uses the generated edge image in reference length definition and rack size measurement to properly obtain the height size of the rack 10. Next, the specific procedure of device registration of the third embodiment is described.

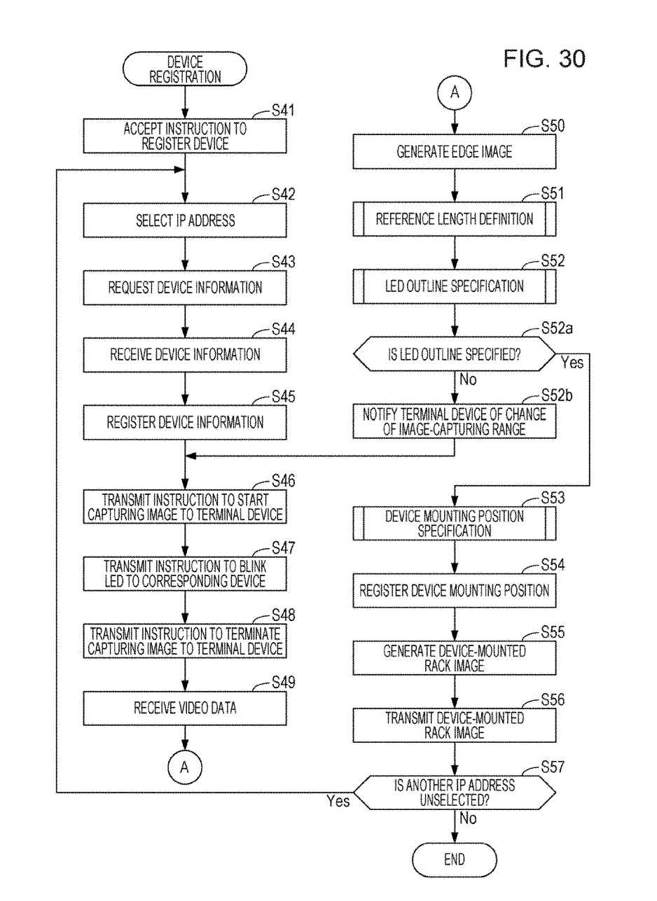

FIG. 30 is a flowchart illustrating an example of device registration of the third embodiment. Hereinafter, the process illustrated in FIG. 30 is described along step numbers. The procedure of FIG. 30 is different from the procedure of device registration illustrated in FIG. 21 in executing steps S52a and S52b between the steps S52 and S53. Hereinafter, the steps S52a and S52b are mainly described, and description of the other steps is omitted.

(S52a) The LED detecting section 144 determines whether the LED outline is specified in the step S52. When the LED outline is specified in the step S52, the process proceeds to step S53. When the LED outline is not specified in the step S52, the process proceeds to the step S52b. The case where the LED outline is not specified refers to the case where an error is detected in the process of the step S66 in FIG. 22. In the third embodiment, the image analysis section 140 continues the process of device registration even when the error is detected in the step S66.

(S52b) The data communication section 120 notifies the terminal device 200 of the movement of the image capturing range. The process proceeds to the step S46. Upon receiving the notification of the movement of the image capturing range from the management server 100, the terminal device 200 displays an instruction to move the image capturing range on the display 205a and prompts the user U10 to change the image capturing range. For example, the user U10 looks at the image within the image capturing range displayed on the display 205a and changes the position of the terminal device 200 relative to the rack 10 so that part of the front view of the rack 10 not yet subjected to image capturing is included in the image capturing range. In the next step S46, the terminal device 200 obtains a video of the part not yet subjected to image capturing upon receiving the instruction to start capturing an image from the management server 100. The management server 100 receives the video from the terminal device 200 and uses the new video data to specify the LED outline. Even if the LED outline of the LED 306 is not specified from the first video data, the management server 100 specifies the LED outline from data of the next video data (and data of video shot later), for example. The user U10 only has to change the image capturing range by changing the position of the terminal device 200 to the rack 10. Accordingly, the operation of the user U10 is simpler than the operation of rack registration and device registration performed over again by the user U10.

To specify the device mounting position in the step S53, the upper or lower side of the rack is specified in the edge image and is used. As illustrated in FIG. 29, the terminal device 200 preferably creates a video by capturing images of two divisions of the entire rack so that one of the images includes the lower end of the rack while the other includes the upper end of the rack. Specifically, the first video includes a lower part of the rack, and the second video includes the upper part thereof. The image analysis section 140 specifies an LED outline and a rectangle including the LED outline inside from a video not including the upper and lower ends of the rack in some cases. In such a case, the image analysis section 140 forms a panorama image including at least one of the upper and lower ends of the rack or any combination thereof and creates an edge image. Based on the edge image created from the panorama image, the image analysis section 140 then measures the distance between the rectangle and the upper or lower side of the rack to specify the mounting position.

With the management server 100, rack registration and device registration are appropriately performed even when the entire front view of the rack 10 does not fall within the field of view of the camera 204 of the terminal device 200. The information processing of the first embodiment is implemented by causing the processor 1b to execute programs. The information processing of the second and third embodiments is implemented by causing the processor 101 to execute programs. The programs are recorded in the computer-readable recording medium 24.

The recording medium 24 with the program recorded is distributed for distribution of the programs. The program may be stored in another computer to be distributed via a network. The computer may be configured to store the programs recorded in the recording medium 24 or received from another computer in the storage device such as the RAM 102 and HDD 103 and read the programs from the storage device for execution.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a management program for causing a computer to execute processes, the process comprising:
acquiring an image of a rack and a device mounted in the rack; and
specifying a position of the device mounted in the rack, in the rack based on the image and correspondence information representing correspondences between aspect ratios of devices mountable in the rack and unit sizes in the rack, each of the unit sizes having a minimum housing space that accommodates the device.

2. The non-transitory, computer-readable recording medium according to claim 1, further comprising:
detecting a rectangle included in the image, and
determining whether the rectangle corresponds to the device mounted in the rack in accordance with comparison between the aspect ratio of the detected rectangle and the aspect ratios in the correspondence information.

3. The non-transitory, computer-readable recording medium according to claim 2, wherein the position is specified based on a distance between a side of the rectangle corresponding to the device mounted in the rack and a side of a top or bottom housing space in the rack, the sides extending in a rack width direction.

4. The non-transitory, computer-readable recording medium according to claim 2, further comprising calculating a quantity of housings of the rack based on length of a side of the rectangle corresponding to the device mounted in the rack in a height direction and length of an entire housing spaces of the rack in the height direction in the image.

5. The non-transitory, computer-readable recording medium according to claim 1, further comprising
acquiring a video of a predetermined operation of the device mounted in the rack, and
detecting a region including a change due to the operation from the video and specify a part of the video corresponding to the device mounted in the rack based on the detected region.

6. The non-transitory, computer-readable recording medium according to claim 1, further comprising:
receiving device information from the device mounted in the rack;
instructing the device which has transmitted the device information to execute a predetermined operation;
acquiring a video of the rack, the device mounted in the rack, and the operation; and
detecting a region corresponding to the operation from the video and use the detected region to associate the device information with the position.

7. The non-transitory, computer-readable recording medium storing the management program according to claim 5, further comprising
blinking a light emitting diode provided in the device mounted in the rack.

8. The non-transitory, computer-readable recording medium according to claim 5, wherein in the detecting, when not detecting the region corresponding to the operation from the video, the computer is configured to instruct the device which has shoot the video to change an image capturing range.

9. The non-transitory, computer-readable recording medium according to claim 1, wherein the aspect ratios are ratios of lengths of the devices mountable in the rack in a rack width direction to lengths of the respective devices in a height direction.

10. A management apparatus comprising:
a memory configured to store correspondence information representing correspondences between aspect ratios of devices mountable in a rack and unit sizes in the rack, each of the unit sizes having a minimum housing space that accommodates the device; and
a processor coupled to the memory and the processor configured to acquire an image of the rack and a device mounted in the rack and specify, in the rack based on the image and the correspondence information, a position of the device mounted in the rack.

11. A management method comprising:
causing a computer to acquire an image of a rack and a device mounted in the rack; and
causing the computer to specify a position of the device mounted in the rack, in the rack based on the image and correspondence information representing correspondences between aspect ratios of devices mountable in a rack and unit sizes in the rack, each of the unit sizes having a minimum housing space that accommodates the device.
